(19) United States
(12) Patent Application Publication
(10) Pub. No.: US 2006/0034084 A1
(43) Pub. Date: Feb. 16, 2006

(54) Light-emitting apparatus and illuminating apparatus

(75) Inventors: Shingo Matsuura, Gamo-gun (JP); Fumiaki Sekine, Gamo-gun (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/168,887

(22) Filed: Jun. 28, 2005

(30) Foreign Application Priority Data
Jun. 28, 2004 (JP) P2004-190459
Aug. 27, 2004 (JP) P2004-247660
Mar. 24, 2005 (JP) P2005-85369

(51) Int. Cl. F21V 9/00; F21V 7/00

(52) U.S. Cl. 362/293; 362/297; 362/304; 362/346

(57) ABSTRACT

The light-emitting apparatus includes a light-emitting element, a base body having, on its upper principal surface, a placement portion for emplacing thereon the light-emitting element; a first reflecting member formed in a frame-like shape and attached to the upper principal surface of the base body so as to surround the placement portion; a second reflecting member formed in a frame-like shape and attached to the upper principal surface of the base body so as to surround the first reflecting member; a light transmitting member provided inside the second reflecting member so as to cover the light-emitting element and the first reflecting member; and a first wavelength-conversion layer for converting a wavelength of light from the light-emitting element, the first wavelength-conversion layer being provided inside the light transmitting member disposed above the light-emitting element, spaced from the first and second reflecting members.

### BACKGROUND OF THE INVENTION

1. Field of the Invention

The present invention relates to a light emitting Apparatus that comprises a light-emitting element caused therein, and to an illuminating apparatus that comprises the apparatus.

2. Description of the Related Art

A conventional light-emitting apparatus is shown in FIG. 15. In FIG. 15, the light-emitting apparatus is composed mainly of a base body 11, a frame reflecting member 12, a light-emitting element 13, a wavelength-conversion layer 15, and a light transmitting member 16. The base body 11 is made of an insulating material and has, at the center of its top surface, a placement portion 11a for emplacing thereon the light-omitting element 13. The base body 11 is also provided with a wiring conductor (not shown) formed of lead terminals and metallized wirings for electrically connecting within and without the light-emitting apparatus by way of the placement portion 11d and its onvirons. The frame reflecting member 12 is fixedly bonded to the top surface of the base body 11 and has an inner peripheral surface 12a inclined to expand outward toward the upper side of the frame and the inner peripheral surface 12a serves as a reflecting surface that reflects the light from the light-emitting element 13. The wavelength-conversion layer 15 is made of a light transmitting member which contains a phosphor material (not shown) therein for performing wavelength conversion of the light from the light-emitting element 13. The light transmitting member 16 injects inside the reflecting member 12 for protecting the light-emitting element 13.

The base body 11 is formed of a ceramic such as sintered aluminium oxide (alumina ceramic), sintered aluminium nitride, sintered mullite or glass ceramic, or a resin such as epoxy resin. When the base body 11 is formed of a ceramic, wiring conductors are formed thereon by baking a metal paste of tungsten (W), molybdenum (Mo)-maganese (Mn) or the like at high temperature. When the base body 11 is formed of a resin, lead terminals of copper (Cu), iron (Fe)-nickel (Ni) alloy or the like are fixedly arranged within the base body 11 through a process of in-mold molding.

The reflecting member 12 is formed of a metal such as aluminium (Al) or Fe—Ni-cobalt (Co) alloy, a ceramic such as alumina ceramic, or a resin such as epoxy resin, and is formed according to a working technique of cutting, in-mold molding or extrusion molding.

The inner peripheral surface 12a of the reflecting member 12 serves as a reflecting surface that reflects the light from the light emitting element 13 and the wavelength-conversion layer 15, and the inner peripheral surface 12a is formed by depositing a metal such as Al by a vapor deposition or plating. The reflecting member 12 is bonded to the upper surface of the base body 11 with a bonding material, for example, a solder material such as soft solder or silver (Ag) solder, or a resin adhesive, in such a manner that its inner peripheral surface 12a surrounds the placement portion 11a.

The light-emitting element 13 comprises a light-emitting layer of, for example, gallium (Ga)—Al-nitrogen (N), zinc (Zn)-sulfur (S), Zn-selenium (Se) silicon (Si)-carbon (C), Ga-phosphorus (P), Ga—Al-arsenic (As), Al-indium (In)—Ga—P, In—Ga—N, Ga—N or Al—In—Ga—N formed on a single-crystal substrate of sapphire by, for example, a liquid-phase growth or MOCVD. The structure of the light-emitting element 13 may be any of a homo junction structure, a heterojunction structure or a double-heterojunction structure including an MIS junction or PN junction. The wavelength range of the light-emitting element 12 may broadly cover from UV light to IR light, depending on the material of the light-emitting layer and the degree of crystal mixture thereof. The light-emitting element 13 is so designed that an electrode of the light-emitting element 13 is electrically connected to the wiring conductors disposed around the placement portion 11a according to a method or using a bonding wire (not shown) or according to a flip chip bonding of bonding the wiring conductors to the electrode of the light-emitting element 13 disposed on the lower side of the device, via solder bumps.

The wavelength-conversion layer 15 is formed of a thermally cured plate of a light transmitting material such as epoxy resin or silicone resin containing a phosphor material. The wavelength-conversion layer 15 covers an opening of the reflecting member 12 so as to absorb the visible light or the UV light from the light-emitting element 13, convert them into other light having a longer wavelength and radiate the thus-converted light. Accordingly, for the wavelength-conversion layer 15, various materials may be used in accordance with the wavelength range of the light from the light-emitting element 13 and the desired light radiated from the light-emitting apparatus. Depending on the material to form the layer 15, therefore, the light-emitting apparatus can be designed in any desired manner so that any desired light having any desired wavelength spectrum can be taken out of the apparatus. When the light from the light-emitting element 13 and the light from the phosphor material are complementary to each other in the light-emitting apparatus, then the apparatus can emit white light.

The phosphor material includes, for example, cerium (Ce)-activated yttrium-aluminium-garnet phosphor, perylene derivatives, Cu or Al-activated cadmium zinc sulfide, Mn-activated magnesium oxide, titanium oxide. One or more of these phosphor materials may be used herein either singly or as combined.

The light transmitting member 16 may be formed of a light transmitting material such as epoxy resin or silicone resin, and protects the light-emitting element 13. Reducing the refractivity difference between the light-emitting element 13 and the light transmitting member 16 prevents light from being confined within the light-emitting element 13.

However, in the conventional light-emitting apparatus as above, after the light from the light-emitting element 13 has been absorbed by the phosphor material in the wavelength-conversion layer 15, phosphor rays having different wavelengths are emitted by the phosphor material in all directions. A part of the phosphor rays are radiated upward through the wavelength-conversion layer 15 to be the radiated light from the light-emitting apparatus, but a part of the others may be radiated downward through the wavelength-conversion layer 15, or may be reflected by any other phosphor material and are thereby radiated also downward through the wavelength-conversion layer 15, and, as a result, they may be repeatedly reflected by the inner peripheral surface 12a of the reflecting member 12 or by the wavelength-conversion layer 15 and are after all confined within the light-emitting apparatus. As the case may be, the part of others may return to the light-emitting element 13 and may be absorbed.

Some rays that have been radiated downward through the wavelength-conversion layer 15 and are therefore not radiated outside may be reflected by the reflecting member 12, after radiated downward, and then again pass through the wavelength-conversion layer 15 to go outside, and after all they may be the emitted light from the light-emitting apparatus. However, of the light thus having passed through the wavelength-conversion layer 15 plural times after the repetitive reflection on the layer, the energy is absorbed by the layer and the radiative light intensity thereof is therefore attenuated.

As in the above, the conventional light-emitting apparatus has a problem in that the radiative light intensity and the brightness of the light-emitting apparatus are difficult to increase.

Accordingly, the invention has been completed in consideration of the related-art problems noted above, and its object is to provide a light-emitting apparatus of good luminous efficiency having high radiative light intensity and high brightness.

The invention provides a light-emitting apparatus comprising:

a light-emitting element;

a base body having, on its upper principal surface, a placement portion for emplacing thereon the light-emitting element;

a first reflecting portion formed in a frame-like shape and on the upper principal surface of the base body so as to surround the placement portion, having an inner peripheral surface serving as a light-reflecting surface;

a second reflecting portion formed in a frame-like shape and on the upper principal surface of the base body so as to surround the first reflecting portion, having an inner peripheral surface serving as a light-reflecting surface;

a light transmitting member provided inside the second reflecting portion so as to cover the light-emitting element and the first reflecting portion; and

a first wavelength-conversion portion for converting a wavelength of light from the light-emitting element, the first wavelength-conversion portion being provided inside or on a surface of the light transmitting member disposed above the light-emitting element, spaced from the first and second reflecting portions.

The invention provides a light-emitting apparatus comprising:

a light-emitting element;

a tabular base body;

a first reflecting portion formed on an upper principal surface of the base body, having, on its upper surface, a placement portion for emplacing the light-emitting element and a side wall portion including an inner peripheral surface serving as a light-reflecting surface, the side wall portion being formed so as to surround the placement portion;

a second reflecting portion formed in a frame-like shape and on the upper principal surface of the base body so as to surround the first reflecting portion, having an inner peripheral surface serving as a light-reflecting surface;

a light transmitting member provided inside the second reflecting portion so as to cover the light-emitting element and the first reflecting portion; and

a first wavelength conversion portion for converting a wavelength of light from the light-emitting element, the first wavelength-conversion portion being provided inside or on a surface of the light transmitting member disposed above the light-emitting element, spaced from the first and second reflecting portions.

In the invention, it is preferable that the second reflecting portions has, on its inner peripheral surface, a second wavelength-conversion portion for converting the wavelength of the light from the light-emitting element.

In the invention, it is preferable that the first wavelength-conversion portion is so positioned that its outer periphery is on a side of the second reflecting portion with respect to a line that runs from an edge of the light-emitting element to an upper edge of the inner peripheral surface of the first reflecting portion opposite to the edge of the light-emitting element.

The invention provides a light-emitting apparatus comprising:

a light-emitting-element;

a base body having, on its upper principal surface, a placement portion for emplacing thereon the light-emitting element;

a first reflecting portion formed in a frame like shape and on the upper principal surface of the base body so as to surround the placement portion, having an inner peripheral surface serving as a light-reflecting surface;

a second reflecting portion formed in a frame like shape and on the upper principal surface or the base body so as to surround the first reflecting portion, having an inner peripheral surface serving as a light-reflecting surface;

a light transmitting member provided inside the second reflecting portion so as to cover the light-emitting element and the first reflecting portion;

a light-reflecting portion for reflecting light from the light-emitting element, the light-reflecting portion being provided inside or on a surface of the light transmitting member disposed above the light-emitting element, spaced from the first and second reflecting portions; and

a wavelength-conversion portion formed on the inner peripheral surface of the second reflecting portion so as to convert the wavelength of the light from the light-emitting element.

The invention provides a light-emitting apparatus comprising:

a light-emitting element;

a tabular base body;

a first reflecting portion formed on an upper principal surface of the base body, having, on its upper surface, a placement portion for emplacing the light-emitting element and a side wall portion including an inner peripheral surface serving as a light-reflecting surface, the side wall portion being formed so as to surround the placement portion;

a second reflecting portion formed in a frame-like shape and on the upper principal surface of the base body so as to surround the first reflecting portion, having an inner peripheral surface serving as a light-reflecting surface;

a light transmitting member provided inside the second reflecting portion so as to cover the light-emitting element and the first reflecting portion;

a light-reflecting portion for reflecting light from the light-emitting element, the light-reflecting portion being provided inside or on a surface of the light transmitting member disposed above the light-emitting element, spaced from the first and second reflecting portions; and

a wavelength-conversion portion formed on the inner peripheral surface of the second reflecting portion so as to convert the wavelength of the light from the light-emitting element.

In the invention, it is preferable that the light reflecting portion is so positioned that its outer periphery in on a side of the second reflecting portion with respect to a line that runs from an edge of the light-emitting element to an upper edge of the inner peripheral surface of the first reflecting portion opposite to the edge of the light-emitting element.

In the invention, it is preferable that the light-reflecting portion has a light-scattering surface facing the light-emitting element.

In the invention, it is preferable that the second wavelength-conversion portion is so formed that its thickness gradually increases from its upper end to its lower end.

In the invention, it is preferable that the wavelength-conversion portion is so formed that its thickness gradually increases from its upper end to its lower end.

In the invention, it is preferable that the second wavelength-conversion portion contains a phosphor material for converting the wavelength of the light from the light-emitting element, and is so formed that the density of the phosphor material therein gradually increases from the upper end to the lower end of the second wavelength-conversion portion.

In the invention, it is preferable that the wavelength-conversion portion contains a phosphor material for converting the wavelength of the light from the light-emitting element, and is so formed that the density or the phosphor material therein gradually increases from the upper end to the lower end of the wavelength-conversion portion.

In the invention, it is preferable that the second wavelength-conversion portion if so formed that its inner surface has plural recesses or protrusions.

In the invention, it is preferable that the wavelength-conversion portion is so formed that its inner surface has plural recesses or protrusions.

In the invention, it is preferable that a height of the placement portion protrudes higher than a lower edge of the inner peripheral surface of the first reflecting portion.

The invention provides an illuminating apparatus constructed by setting up the light-emitting apparatus mentioned above in a predetermined arrangement.

According to the invention, the light-emitting apparatus comprises a light-emitting element; a base body having, on its upper principal surface, a placement portion for emplacing thereon a light-emitting element; a first reflecting portion formed in a frame-like shape and on the upper principal surface of the base body so as to surround the placement portion, having an inner peripheral surface serving as a light-reflecting surface; a second reflecting portion formed in a frame-like shape and on the upper principal surface of the hash body so as to surround the first reflecting portion, having an inner peripheral surface serving as a light-reflecting surface; a light transmitting member provided inside the second reflecting portion 30 as to cover the light-emitting element and the first reflecting portion; and a first wavelength conversion portion for converting a wavelength of light from the light-emitting element, the first wavelength-conversion portion being provided inside or on a surface of the light transmitting member disposed above the light-emitting element, spaced from the first and second reflecting portions. Accordingly, this makes it possible to undergo wavelength conversion of the light from the light-emitting element by the first wavelength-conversion portion, then reflect the converted light radiated downward from the first wavelength-conversion portion upward by the second reflecting portion and radiate the reflected light outside the light-emitting apparatus through a gap between the first wavelength-conversion portion and the second reflecting portion, without being transmitted through the first wavelength-conversion portion again. As a result, it is possible to extremely effectively prevent the light radiated downward from the first wavelength-conversion portion from being confined within the light-emitting apparatus, and to realize the light-emitting apparatus having advantages of high radiative light intensity, high brightness and high luminous efficiency.

According to the invention, the light-emitting apparatus comprises a light-emitting element; a tabular base body; a first reflecting portion formed on an upper principal surface of the base body, having, on its upper surface, a placement portion for emplacing a light-emitting element and a side wall portion including an inner peripheral surface serving as a light-reflecting surface, the side wall portion being formed so as to surround the placement portion; a second reflecting portion formed in a frame-like shape and on the upper principal surface of the base body so as to surround the first reflecting portion, having an inner peripheral surface serving as a light-reflecting surface; a light transmitting member provided inside the second reflecting portion so as to cover the light-emitting element and the first reflecting portion; a first wavelength-conversion portion for converting a wavelength of light from the light-emitting element, the first wavelength-conversion portion being provided inside or on the surface of the light transmitting member disposed above the light-emitting element, spaced from the first and second reflecting portions. Accordingly, this makes it possible to undergo wavelength conversion of the light from the light-emitting element by the first wavelength-conversion portion, then reflect the converted light radiated downward the first wavelength-conversion portion upward by the second reflecting portion and radiate the reflected light outside the light-emitting apparatus through a gap between the first wavelength-conversion portion and the second reflecting portion, without being transmitted through the first wavelength-conversion portion again. As a result, it is possible to extremely effectively prevent the light radiated downward from the first wavelength-conversion portion from being confined within the light-emitting apparatus, and to realize the light-emitting apparatus having advantages of high radiative light intensity, high brightness and high luminous efficiency.

Further, the heat generated by the light-emitting element can be readily conducted to the side wall portion integrated with the placement portion. In particular, when the first reflecting portion is formed of a metal, the heat can be rapidly conducted to the side wall portion and is well radiated through an outer surface of the side wall portion. As a result, it is possible to prevent the temperature increase in the light-emitting element and to prevent generation of crack of a bonding part of the light-emitting element and the first reflecting portion owing to thermal expansion difference therebetween. Further, the heat of the light-emitting element can be favorably moved not only in the direction of the height of the first reflecting portion but also in the outer peripheral direction thereof, whereby the efficient thermal conduction to the base body from the entire lower surface of the first reflecting portion results in more effective prevention of the temperature increase in the light-emitting element and the first reflecting portion, and, as a result, the light-emitting element can be stably driven and the inner peripheral surface of the first reflecting portion can be prevented from being thermally deformed. Accordingly, the light-emitting apparatus can be driven stably for a long period of time and its good light-emitting capability is kept long.

According to the invention, in the light-emitting apparatus, the second reflecting portion has, on its inner peripheral surface, a second wavelength-conversion portion for converting the wavelength of the light from the light-emitting element. Accordingly, the light from the light-emitting element that has been reflected downward without wavelength conversion in the first wavelength-conversion portion can undergo wavelength conversion in the second wavelength-conversion portion, and therefore, it is possible to improve radiative light intensity, brightness and luminous efficiency.

According to the invention, the first wavelength-conversion portion is so positioned that its outer periphery is on a side of the second reflecting portion with respect to a line that runs from an edge of the light emitting element to an upper edge of the inner peripheral surface of the first reflecting portion opposite to the edge of the light-emitting element. Accordingly, it is possible to prevent the light from the light-emitting element from being directly radiated outside the light-emitting apparatus. As a result, the light-emitting apparatus enables light emission with no fluctuation in the emitted light color and the light emission distribution.

According to the invention, the light-emitting apparatus comprises a light-emitting element; a base body having, on its upper principal surface, a placement portion for emplacing thereon a light-emitting element; a first reflecting portion formed in a frame-like shape and on the upper principal surface of the base body so as to surround the placement portions having an inner peripheral surface serving as a light-reflecting surface; a second reflecting portion formed in a frame-like shape and on the upper principal surface of the base body so as to surround the first reflecting portion, having an inner peripheral surface serving as a light-reflecting surface; a light transmitting member provided inside the second reflecting portion so as to cover the light-emitting element and the first reflecting portion; a light-reflecting portion for reflecting light from the light-emitting element, the light-reflecting portion being provided inside or on a surface of the light transmitting member diposed above the light-emitting element, spaced from the first and second refecting portions; and a wavelength-conversion portion formed on the inner peripheral surface of the second reflecting portion so as to convert the wavelength of the light from the light-emitting element. Accordingly, it is possible to emit the light from the light-emitting element outside with high intensity.

Specifically, the light from the light-emitting element is gathered on the light-reflecting portion by the first reflecting portion and reflected downward, and then the reflected light is reflected upward by the second reflecting portion and is radiated outside the light-emitting apparatus. The wavelength-conversion portion is formed on the reflecting surface of the second reflecting portion. Therefore, of the light from the light-emitting element, the part having passed through the wavelength conversion portion not directly radiated outside is changed into a desired light color and is then radiated outside. Even the light that runs below the wavelength-conversion portion and in various directions without being radiated outside in conventional systems can run in the apparatus of the invention from the upper surface of the wavelength-conversion portion and then go out through the upper surface of the wavelength-conversion portion, as reflected by the second reflecting portion, and therefore, the light is not confined within the wavelength-conversion portion. Accordingly, it is possible to efficiently emit light upward. As a result, the light having undergone wavelength conversion is effectively radiated upward the apparatus through the wavelength-conversion portion, and thereby it is possible to prevent the converted light from being confined within the light-emitting apparatus.

Of the light radiated through the wavelength-conversion portion after having been reflected by the light-reflecting portion, the part that returns to and is absorbed by the light-emitting element is reduced since the first reflecting portion is so positioned as to surround the light-emitting element, and a ratio thereof is therefore extremely small. Accordingly, it is possible to realize the light emitting apparatus which increases the realize light intensity and the brightness extremely effectively, and ensures increased luminous efficiency.

According to the invention, the light-emitting apparatus comprises a light-emitting element; a tabular base body; a first reflecting portion formed on an upper principal surface of the base body, having, on its upper surface, a placement portion for emplacing thereon a light-emitting element and a side wall portion including an inner peripheral surface serving as a light-reflecting surface, the side wall portion being formed so as to surround the placement portion; a second reflecting portion formed in a frame-like shape and on the upper principal surface of the base body so as surround the first reflecting portion, having an inner peripheral surface serving as a light-reflecting surface; a light transmitting member provided inside the second reflecting portion so as to cover the light emitting element and the first reflecting portion; a light-reflecting portion for reflecting light from the light-emitting element, the light-reflecting portion being provided inside or on a surface of the light transmitting member disposed above the light-emitting element, space from the first and second reflecting portions; and a wavelength-conversion portion formed on the inner peripheral surface of the second reflecting portion so as to convert the wavelength of the light from the light-emitting element. Accordingly, it is possible to emit the light from the light-emitting element outside with high intensity.

Specifically, the light from the light-emitting element is gathered on the light-reflecting portion by the first reflecting portion and reflected downward, and then the reflected light is reflected upward by the second reflecting portion and is radiated outside the light-emitting apparatus. The wavelength-conversion portion is formed on the reflecting surface of the second reflecting portion. Therefore, of the light from the light-emitting element, the part having passed through the wavelength-conversion portion not directly radiated outside is changed into a desired light color and is then radiated outside. Even the light that runs below the wavelength-conversion portion and in various directions without being radiated outside in conventional systems can run in the apparatus of the invention from the upper surface of the wavelength conversion portion and then go out through the upper surface of the wavelength-conversion portion, as reflected by the second reflecting portion, and therefore the light is not confined within the wavelength conversion portion. Accordingly, it is possible to efficiently emits light upward. As a result, the light having undergone wavelength conversion is effectively radiated upward the apparatus through the wavelength-conversion portion and thereby it is possible to prevent the converted light from being confined within the light-emitting apparatus.

Of the light radiated through the wavelength-conversion portion after having been reflected by the light-reflecting portion, the part that returns to and is absorbed by the light-emitting element is reduced since the first reflecting portion is so positioned as to surround the light-emitting element, and a ratio thereof is therefore extremely small. Accordingly, it is possible to realize the light-emitting apparatus which increases the radiative light intensity and the brightness extremely effectively, and ensures increased luminous efficiency.

Further, the heat generated by the light-emitting element can be readily conducted to the placement portion and to the side wall portion integrated with the placement portion. In particular, when the first reflecting portion is formed of a metal, the heat can be rapidly conducted to the placement portion and to the side wall portion therearound and is further conducted to the base body through the entire lower surface of the first reflecting portion. Then, the heat is favorably radiated outside through an outer surface of the base body. As a result, it is possible to prevent the temperature increase in the light-emitting element and to prevent generation of crack of a bonding part of the light-emitting element and the first reflecting portion owing to the thermal expansion difference therebetween. Further, efficient thermal conduction to the base body from the entire lower surface of the first reflecting portion results in more effective prevention of the temperature increase in the light-emitting element and the first reflecting portion, whereby the light-emitting element can be stably driven and the inner peripheral surface of the first reflecting portion can be prevented from being thermally deformed. Accordingly, the light-emitting apparatus of the invention can be driven stably for a long period of time and its good light-emitting capability is kept long.

According to the invention, the light-reflecting portion is so positioned that its outer periphery is on a side of the second reflecting portion with respect to a line that runs from an edge of the light-emitting element to an upper edge of the inner peripheral surface of the first reflecting portion opposite to that edge of the light-emitting element. Accordingly, a major part of the light from the light-emitting element is gathered on the light-reflecting portion and is reflected downward. Therefore, it is possible to prevent the light from being directly radiated outside the light-emitting apparatus without passing through the wavelength-conversion portion. As a result, the light-emitting apparatus can emit high-intensity light having a desired wavelength spectrum with no fluctuation in the emitted light color and the light emission distribution.

In case where much light directly goes outside from the light-emitting element without passing through the wavelength-conversion portion, the quantity of light capable of being converted to have a desired wavelength is reduced and the radiative light intensity is also reduced. However, where the light-reflecting portion is so positioned that its outer periphery is on the side of the second reflecting portion with respect to the line that runs prom the edge of the light-emitting element to the upper edge of the inner peripheral surface of the first reflecting portion opposite to the edge of the light-emitting element, the quantity of light from the light-emitting element that is directly radiated outside the apparatus through a gap between the light-reflecting portion and the first reflecting portion can be reduced. In that manner, a major part of the light from the light-emitting element can be led through the wavelength-conversion portion, and therefore the quantity of light that undergoes wavelength conversion can be increased whereby the wavelength conversion efficiency is improved and the light having a desired wavelength spectrum can be radiated from the apparatus with high intensity.

According to the invention, since the light-reflecting portion has a light-scattering surface facing the light-emitting element, it is possible to effectively reflect the light from the light-emitting element downward and outward, so that the reflected light can be led inside the wavelength-conversion portion.

According to the invention, the second wavelength-conversion portion or the wavelength-conversion portion is so formed that its thickness gradually increases from its upper end to its lower end. Accordingly, the quantity of light from the phosphor material gradually increases toward the lower end of the second wavelength-conversion portion or the wavelength-conversion portion at which the distance between the upper surface of the light transmitting member and the second wavelength-conversion portion or the wavelength-conversion portion is larger, but toward the upper end of the second wavelength-conversion portion or the wavelength-conversion portion at which the distance between the upper surface of the light transmitting member and the second wavelength-conversion portion or the wavelength-conversion portion is smaller, the quantity of light from the phosphor material is gradually smaller than that toward the lower end thereof. As a result, the light intensity distribution in the light-emitting apparatus can be made uniform in the center part and in the peripheral part of the apparatus, and color unevenness is prevented from occurring in the apparatus.

According to the invention, the second wavelength-conversion portion or the wavelength conversion portion contains a phosphor material for converting the wavelength of the light from the light-emitting element, and is so formed that the density of the phosphor material therein gradually increases from the upper end to the lower end of the second wavelength-conversion portion or the wavelength-conversion portion. Accordingly, the quantity of light from the phosphor material gradually increases toward the lower end of the second wavelength-conversion portion or the wavelength-conversion portion at which the distance between the upper surface of the light transmitting member and the second wavelength-conversion portion or the wavelength-conversion portion is larger, but toward the upper end of the second wavelength conversion portion or the wavelength-conversion portion at which the distance between the upper surface of the light transmitting member and the second wavelength-conversion portion or the wavelength-conversion portion is smaller, the quantity of light from the phosphor material is gradually smaller than that toward the lower end thereof. As a result, the light intensity distribution in the light-emitting apparatus can be made uniform in the center part and in the peripheral part of the apparatus, and color unevenness ran be prevented from occurring in the apparatus.

Further, the light from the light-emitting element that has been reflected downward and outward without wavelength conversion in the first wavelength-conversion portion can undergo wavelength conversion by the action of the phosphor material having an increased density, and therefore, in the light-emitting apparatus, high radiative light intensity, high brightness and improved luminous efficiency are achieved.

According to the invention, the second wavelength-conversion portion or the wavelength-conversion portion is so formed that its inner surface has plural recesses or protrusions. Accordingly, the light from the light-emitting element that has been transmitted to the first wavelength-conversion portion directly or after reflection on the inner peripheral surface of the first reflecting portion, and has been reflected downward and outward and enters the second wavelength-conversion portion with no wavelength conversion by the action of the phosphor material contained in the first wavelength-conversion portion, or the light from the light-emitting element that has been transmitted to the light-reflecting portion directly or after reflection on the inner peripheral surface of the first reflecting portion, and has been reflected by the light-reflecting portion downward and outward and enters the wavelength-conversion portion, is readily led inside the second wavelength-conversion portion or the wavelength-conversion portion owing to the recesses and the protrusions, and, as a result, the light to undergo wavelength conversion by the action of the phosphor material in the second wavelength-conversion portion or the wavelength-conversion portion increases. Accordingly, in the light-emitting apparatus, high radiative light intensity, high brightness and improved luminous efficiency are archieved.

In addition, since the surface area of the second wavelength-conversion portion or the wavelength-conversion portion increases owing to the plural recesses and protrusions and therefore the amount of the phosphor material exposed out on the surface of the second wavelength-conversion portion or the wavelength-conversion portion also increases, the phosphor material in the second wavelength-conversion portion or the wavelength-conversion portion is readily activated by the light that has been reflected downward and outward with no wavelength conversion by the action of the phosphor material contained in the first wavelength-conversion portion, or by the light that has been reflected downward and outward by the light-reflecting portion and, as a result, the quantity of light that undergoes wavelength conversion by the action of the phosphor material in the second wavelength-conversion portion or the wavelength-conversion portion increases. Accordingly, in the light-emitting apparatus, high radiative light intensity, high brightness and improved luminous efficiency are achieved.

According to the invention, the height of the placement portion protrudes higher than the lower edge of the inner peripheral surface of the first reflecting portion. Accordingly, the light emitted by the light-emitting element in the oblique downward direction can be efficiently reflected upward on the inner peripheral surface of the first reflecting portion, and, as a result, the light from the light-emitting element can be prevented from being confined within the light-emitting apparatus by the lower edges of the inner peripheral surface of the first reflecting portion. Accordingly in the light-emitting apparatus of the type, the light absorption loss on the inner peripheral surface of the first reflecting portion with respect to the light from the light-emitting element may be reduced. As a result, the radiative light intensity of the light-emitting apparatus can be increased.

According to the invention, the illuminating apparatus is constructed by setting up the light-emitting apparatus mentioned above in a predetermined arrangement. In this illuminating apparatus, light emission is affected by exploiting recombination of electrons in the light-emitting element composed of a semiconductor. Thus, the illuminating apparatus can be made compact and have the advantage, in terms of power saving and long lifetime, over a conventional illuminating apparatus for effecting light emission through electrical discharge. As a result, variation in the center wavelength of the light emitted from the light-emitting element can be suppressed; wherefore the illuminating apparatus is capable of irradiating light with stable radiation light intensity and stable radiation light angle (luminous intensity distribution) for a longer period of time. Moreover, unevenness in color and unbalanced illumination distribution can be prevented from occurring on a to-be-irradiated surface.

Moreover, by setting up the light-emitting apparatuses of the invention in a predetermined arrangement as light sources, followed by arranging around the light emitting apparatuses such a component as is optically designed in a suitable configuration, for example a reflection jig, an optical lens, and a light diffusion plate, it is possible to realize an illuminating apparatus which is capable of emitting light with suitable luminous intensity distribution.

### BRIEF DESCRIPTION OF THE DRAWINGS

Other and further objects, features, and advantages of the invention will be more explicit from the following detailed description taken with reference to the drawings wherein:

FIG. 1 is a cross-sectional view showing a light-emitting apparatus according to a first embodiment of the invention;

FIG. 2 is a cross sectional view showing a light-emitting apparatus according to a second embodiment of the invention;

FIG. 3 is a cross sectional view showing a light-emitting apparatus according to a third embodiment of the invention;

FIG. 4 is a cross-sectional view showing a light-emitting apparatus according to a fourth embodiment of the invention;

FIG. 5 is a cross-sectional view showing a light-emitting apparatus according to a fifth embodiment of the invention;

FIG. 6 is a cross-sectional view showing a light-emitting apparatus according to a sixth embodiment of the invention;

FIG. 7 is a view showing a light-emitting apparatus according to a seventh embodiment of the invention;

FIG. 8 is a cross-sectional view showing a light-emitting apparatus according to an eighth embodiment of the invention;

FIGS. 9A and 9B are cross-sectional views each showing a light-emitting apparatus according to a ninth embodiment of the invention in different sites;

FIG. 10 is a cross-sectional view showing a light-emitting apparatus according to a tenth embodiment of the invention:

FIG. 11 is a cross-sectional view showing a light-emitting apparatus according to an eleventh embodiment of the invention;

FIG. 12 is a cross-sectional view showing a light-emitting apparatus according to a twelfth embodiment of the invention:

FIG. 13 is a cross-sectional view showing a light-emitting apparatus according to a thirteenth embodiment of the invention;

FIG. 14 is a cross-sectional view showing a light emitting apparatus according to a fourteenth embodiment of the invention;

FIG. 15 is a cross-sectional view showing a light-emitting apparatus according to a fifteenth embodiment of the invention;

FIG. 16 is a cross-sectional view showing a light-emitting apparatus according to a sixteenth embodiment of the invention;

FIG. 17 is a cross-sectional view showing a light-emitting apparatus according to a seventeenth embodiment of the invention;

FIG. 18 is a cross-sectional view showing a light emitting apparatus according to a eighteenth embodiment of the invention;

FIG. 19 is a cross-sectional view showing a light-emitting apparatus according to a nineteenth embodiment of the invention;

FIG. 20 is a cross-sectional view showing a light-emitting apparatus according to a twentieth embodiment or the invention;

FIG. 21 is a cross-sectional view showing a light-emitting apparatus according to a twenty first embodiment of the invention;

FIGS. 22A and 22B are cross-sectional views each showing a light-emitting apparatus according to a twenty-second embodiment of the invention in different sites;

FIG. 23 is a cross-sectional view showing a light-emitting apparatus according to a twenty-third embodiment of the invention;

FIG. 24 is a cross-sectional view showing a light-emitting apparatus according to a twenty-fourth embodiment of the invention;

FIG. 25 is cross-sectional view showing a light-emitting apparatus according to a twenty-fifth embodiment of the invention;

FIG. 26 is a plan view showing an illuminating apparatus according to one embodiment of the invention;

FIG. 27 is a cross-sectional view of the illuminating apparatus of FIG. 26;

FIG. 28 is a plan view showing an illuminating apparatus according to another embodiment of the invention;

FIG. 29 is a cross-sectional view of the illuminating apparatus of FIG. 28; and

FIG. 30 is a cross-sectional view or a conventional light-emitting apparatus.

### DETAILED DESCRIPTION OF THE PREFERRED EMBODIMENTS

Now referring to the drawings, preferred embodiments of the invention are described below.

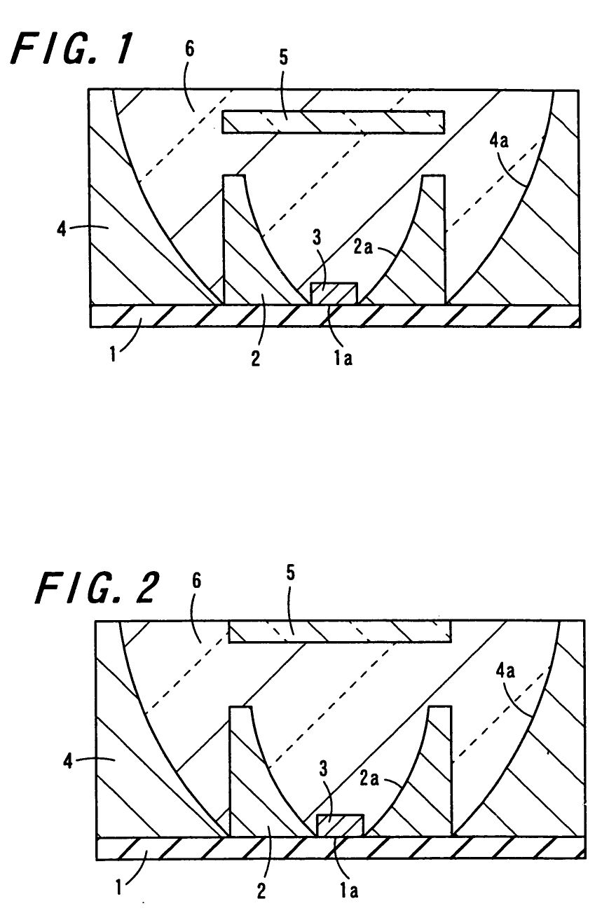

The light-emitting apparatus of the invention is described in retail hereinunder. FIG. 1 is a cross sectional view showing a light-emitting apparatus according to a first embodiment of the invention. The light-emitting apparatus is essentially comprised of a base body 1; a first reflecting member 2 serving as a first reflecting portion; a light-omitting element 3; a second reflecting member 4 serving as a second reflecting portion; a light transmitting member 6 injected inside the second reflecting member 4; a first wavelength-conversion layer 5 serving as a first wavelength-conversion portion. The first wavelength-conversion layer 5 converts a wavelength of light from the light-emitting element 3 to generate phosphor light. The first wavelength-conversion layer 5 is provided inside or on a surface of the light transmitting member 6 (in FIG. 1, inside the member) disposed above the light-emitting element 3, spaced from the first reflecting member 2 and the second reflecting member 4.

The base body 1 is formed of a ceramics material such as alumina ceramics, sintered aluminium nitride, sintered mullite or glass ceramics, or a metal such as Fe—Ni—Co alloy or Cu—W, or a resin such as epoxy resin. A placement portion 1a for emplacing thereon the light-emitting element 3 is formed on an upper surface of the base body 1.

The first reflecting member 2 is bonded to the upper principal surface of the base body 1 so as to surround the placement portion 1a, and the second reflecting member 4 is also attached onto the upper principal surface of the base body 1 so as to surround the first reflecting member 2, with a bonding material, for example, a solder material such as soft solder or Ag solder, or a resin adhesive such as epoxy resin. The first reflecting member 2 is bonded with a desired surface accuracy around the light-emitting element 3 (for example, in such a condition that the light-reflecting surface thereof disposed on both sides of the light-emitting element 3 so as to sandwich the light-emitting element 3 therebetween can be symmetric to each other in the vertical cross-section of the light-emitting apparatus) to thereby form an inner peripheral surface (hereinafter referred to as the first inner peripheral surface) 2a; and the second reflecting member 4 is bonded also with a desired surface accuracy around the first reflecting member 2 to thereby form an inner peripheral surface (hereinafter referred to as the second inner peripheral surface) 4a. According to such a constitution, not only the phosphor light from an upper surface and a side surface of the first wavelength-conversion layer 5, but also the phosphor light from a lower surface of the first wavelength-conversion layer 5 can be reflected on the second inner peripheral surface 4a, and therefore the light can be efficiently outputted to an outside of the light-emitting apparatus. As a result, the light-emitting apparatus has high radiative light intensity and high brightness used has improved luminous efficiency. In addition, the light from the light-emitting element 3 can be uniformly and evenly reflected on the first inner peripheral surface 2a toward the first wavelength-conversion layer 5, and the light from the light-emitting apparatus is tree from a problem of color unevenness.

Preferably, the vertical cross-sectional profile of the second inner peripheral surface 1a of the second reflecting member 4 has a concavely-curved surface. With that, the phosphor light radiated downward from the first wavelength-conversion layer 5 is reflected upward on the second inner peripheral surface 4a with high directional orientation and is radiated outside the light-emitting apparatus. Accordingly, the light-emitting apparatus of the type is most suitable as an illuminating apparatus capable of radiating light efficiently to the irradiated surface.

The first reflecting member 2 and the second reflecting member 4 may be integrated by forming them through in-mold molding or cutting. According to such a constitution, the heat of the light-emitting element 3 may be diffused wholly in the light-emitting apparatus via the first reflecting member 2 and the second reflecting member 4 and the heat-radiative area of the light-emitting apparatus increases, and, as a result, the temperature increase in the light-emitting element 3 is prevented.

If desired, the first wavelength-conversion layer 5 may be disposed above the light-emitting element 3 and on the surface of the light transmitting member 6, spaced from the first reflecting member 2 and the second reflecting member 4, as a light-emitting apparatus according to a second embodiment, of the invention shown in FIG. 2 In this case, the light from the first wavelength-conversion layer 5 is readily radiated outside the light-emitting apparatus, and the luminous efficiency of the light-emitting apparatus can be thereby increased and the radiative light intensity and the brightness of the apparatus can also be increased.

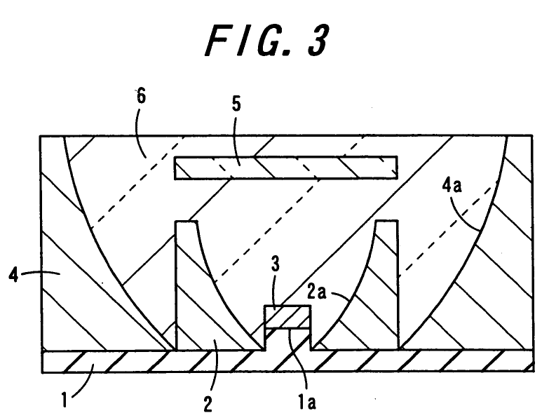

Preferably, the height of the placement portion 1a protruded higher than a lower edge of the first inner peripheral surface 2a of the first reflecting member 2, as a light-emitting apparatus according to a third embodiment of the invention shown in FIG. 3. With that, the light emitted in the oblique downward direction by the light-emitting element 3 can be efficiently reflected upward on the first inner peripheral surface 2a and propagated to the first wavelength-conversion layer 5, and, as a result, the quantity of light from the light-emitting element 3 that undergoes wavelength conversion in the first wavelength-conversion layer 5 increases and the intensity of light radiation from the light-emitting apparatus increases.

The protruded placement portion 1a may be formed by removing a part therearound through polishing, cutting or etching, or by laminating ceramic green sheets to form the base body 1 and the placement portion 1a followed by firing and integrating them. Thus formed, the placement portion protrudes above the base body 1. Alternatively, a different member to be the placement portion 1a may be bonded to the upper principal surface of the base body 1 with an adhesive or the like. For example, a member to be the placement portion 1a that is formed of a ceramics material such as alumina ceramics, sintered aluminium nitride, sintered mullite or glass ceramics, or a metal such as Fe—Ni—Co alloy or Cu—W, or a resin material such as epoxy resin may be bonded to the upper principal surface of the base body 1 with a bonding material such as a solder material or an adhesive.

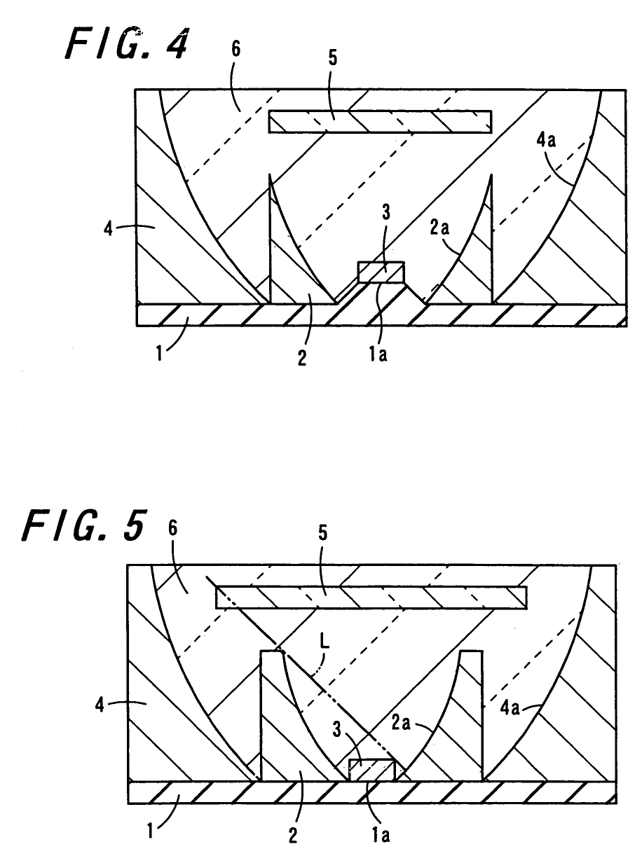

Preferably, the placement portion 1a is so formed that its side surface is inclined to expand outward toward the lower side thereof, as a light-emitting apparatus according to a fourth embodiment of the invention shown in FIG. 4. Accordingly, when a liquid resin to be the light transmitting member 6 but not as yet thermally cured is injected into the area above the second reflecting member 4, an air layer is effectively prevented from being formed in the corner between the protruded placement portion 1a and the upper principal surface of the base body 1 or the lower end of the first inner peripheral surface 2a. Further, the light from the light-emitting element 3 is favorably reflected in the upward direction or in the direction toward the first inner peripheral surface 2a on the side surface of the protruded placement portion 1a, and as a result, the intensity of light radiation from the light-emitting apparatus can be further improved. Moreover, the heat generated in the light light-emitting element 3 can be efficiently diffused toward the side of the base body 1 via the placement portion 1a, and the temperature increase in the light-emitting element 3 is more effectively retarded.

A wiring conductor (not shown) for electrically connecting the light-emitting element 3 is formed in the placement portion 1a. The wiring conductor is electrically led to an outer surface of the light-emitting apparatus via the wiring layer (not shown) formed inside the base body 1 and is electrically connected to an external electric circuit, whereby the light-emitting element 3 is electrically connected to the external electric circuit.

The first reflecting member 2 and the second reflecting member 4 are formed of a high-reflectivity metal such as Al, Ag, Au, platinum (Pt), titanium (Ti) Chromium (Cr) or Cu through cutting or in-mold molding. Alternatively, in a case where the first reflecting member 2 and the second reflecting member 4 are formed of an insulating material such as ceramics or resin (including a case where the first reflecting member 2 and the second reflecting member 4 are metal), the first inner peripheral surface 2a and the second inner peripheral surface 4a, respectively, may be coated with a thin film of a high-reflectivity metal such as Al, Ag, Au, Pt, Ti, Cr or Cu formed thereon through plating or vapor deposition. Furthermore, when the first inner peripheral surface 2a and the second inner peripheral surface 4a are formed of a metal readily discoloring through oxidation, such as Ag or Cu, it is desirable that the surfaces are coated with, for example, an Ni plating layer having a thickness of from 1 to 10 μm or so and an Au plating layer having a thickness of from 0.1 to 3 μm or so formed thereon in that order through electrolytic plating or electroloss plating. According to such a constitution, the corrosion resistance of the first inner peripheral surface 2a and the second inner peripheral surface 4a is improved and the reflectivity thereof is prevented from being lowered.

Preferably, the arithmetic mean roughness Ra of the first inner peripheral surface 2a and the second inner peripheral surface 4a is from 0.004 to 4 μm. With that, the light from the light-emitting element 3 and the phosphor light from the first wavelength-conversion layer 5 can be favorably reflected. In a case where Ra is larger than 4 μm, then the light from the light-emitting element 3 and the first wavelength-conversion layer 5 could not be uniformly reflected on the surfaces and irregular reflection inside the light-emitting apparatus may occur to increase the light loss. On the other hand, in a case where Ra is smaller than 0.004 μm, then the surfaces of the type will be difficult to be stably and efficiently formed.

Furthermore, the first reflecting member 2 may be so modified with no problem that the vertical cross-sectional profile of the outer peripheral surface thereof is curved or plural reflecting members are provided between the first reflecting member 2 and the second reflecting member 4.

Also preferably, the distance between the upper surface of the first reflecting member 2 and the lower surface of the first wavelength-conversion layer 5 is from 0.5 to 3 mm. In a case where the distance is smaller than 0.5 mm, then the phosphor light radiated downward from the first wavelength-conversion layer 5 will be difficult to reflect on the second reflecting member 4 disposed outside the first reflecting member 2, and the light radiation efficiency of the apparatus will be difficult to increase. In a case where the distance is larger than 3 mm, then the light from the light-emitting element 3 will be readily radiated outside the apparatus directly through the gap between the first wavelength-conversion layer 5 and the first reflecting member 2 without passing through the first wavelength-conversion layer 5, and, as a result, the radiated light will have a trouble of color unevenness and intensity unevenness.

The light-emitting element 3 is electrically connected to the wiring conductor formed on the base body 1 according to a wire bonding or according to a flip chip bonding of bonding the wiring conductor to the electrode of the light-emitting element 3 disposed on the lower side of the element, via a solder bump. Preferably, they are bonded according to the flip chip bonding. In that manner, the wiring conductor may be disposed just below the light-emitting element 3, and therefore there is no necessity of providing a space for the wiring conductor on the upper surface of the base body 1 around the light-emitting element 3. Accordingly, the light from the light-emitting element 3 is effectively prevented from being absorbed by the space for the wiring conductor of the base body 1 to lower the radiative light intensity.

The wiring conductor may be provided, for example, by forming a metallized layer of a metal powder of W, Mo, Cu, Ag or the like, or by burying a lead terminal of an Fe—Ni—Co alloy or the like, or by fitting and bonding an input-output terminal formed of an insulator with a wiring conductor formed therein, into the through-hole formed in the base body 1.

Preferably, the surface on which the wiring conductor is exposed out is covered with a corrosion-resistant motel such as Ni or Au in a thickness of from 1 to 20 μm. With that, the wiring conductor may be effectively protected from oxidative corrosion, and the electric connection between the light-emitting element 3 and the wiring conductor may be reinforced. Accordingly, it is more desirable that the exposed surface of the wiring conductor is covered with, for example, an Ni plating layer having a thickness of from 1 to 10 μm or so and an Au plating layer having a thickness of from 0.1 to 3 μm or so formed thereon in that order through electrolytic plating or electroless plating.

The light transmitting member 6 is formed of a light transmitting resin material such as epoxy resin or silicone resin or formed of light transmitting glass. The light transmitting member 6 covers the light-emitting element 3 and optionally the first wavelength-conversion layer 5, and is injected inside the first reflecting member 2 and the second reflecting member 4. According to such a constitution, the refractivity difference between the inside and the outside of the light-emitting element 3 and the first wavelength-conversion layer 5 is reduced, and more light can be taken out from the light-emitting element 3 and the first wavelength-conversion layer 5. In addition, when the light transmitting member 6 is formed of the same material as the light transmitting material to form the wavelength conversion layer 5, then the light emission intensity from the light-emitting apparatus is increased and the radiative light intensity and the brightness of the apparatus can be remarkably increased.

The first wavelength-conversion layer 5 comprises a phosphor material capable of converting the wavelength of the light from the light-emitting element 3, and a light transmitting material such as epoxy resin, silicone resin or glass. For example, a mixture of the materials is previously shaped in a film or plate, and the thermally cured in an oven or the like to give the layer 5. Thus formed, the first wavelength-conversion layer 5 is disposed above the light-emitting element 3 so as to cover the first reflecting member 2 and a part of the second reflecting member 4. According to such a constitution, the wavelength of the light radiated directly by the light-emitting element 3 and that of the light reflected on the first reflecting member 2 are converted by the phosphor material, and the intended light having a desired wavelength spectrum can be taken out of the apparatus.

Preferably, the first wavelength-conversion layer 5 is so positioned that its outer periphery is on a side of the second reflecting member 4 with respect to a line that runs from an edge of the light-emitting element 3 to an upper edge of the inner peripheral surface 2a of the first reflecting member 2 opposite to the edge of the light-emitting element 3, as a light-emitting apparatus according to a fifth embodiment of the invention shown in FIG. 5. According to such a constitution, the light from the light-emitting element 3 is prevented from directly radiating outside the light-emitting apparatus. As a result, the light-emitting apparatus can radiate light with neither color unevenness nor light distribution unevenness.

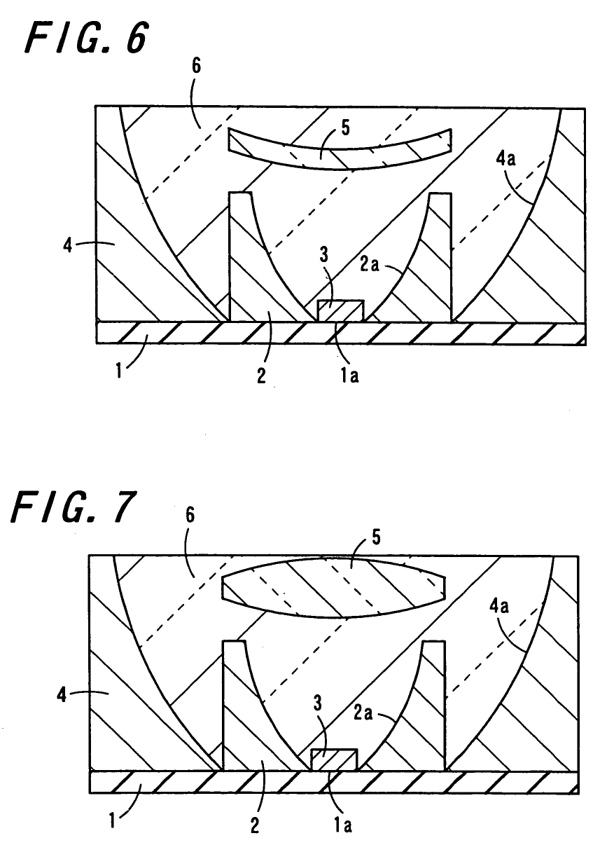

Preferably, the first wavelength-conversion layer 5 is so formed that its vertical cross section has a surface curved convexly toward the light-emitting element 3, as a light-emitting apparatus according to a sixth embodiment of the invention shown in FIG. 6. According to such a constitution, the phosphor light from the lower surface of the first wavelength-conversion layer 5 is led uniformly to the second inner peripheral surface 4a of the second reflecting member 4, and the reflected light from the second inner peripheral surface 4a is free from color unevenness. Accordingly, the optical properties of the light-emitting apparatus are thereby improved.

Preferably, the first wavelength-conversion layer 5 is so formed that its cross-sectional profile is curved convexly toward the side of the light-emitting element 3 and its thickness is proportional to the emission intensity distribution of the light-emitting element 3 in such a manner that the thickness of the first wavelength-conversion layer 5 increases with the increase in the emission intensity of the light-emitting element 3, as a light-emitting apparatus according to a seventh embodiment of the invention shown in FIG. 7. As a result, even the light from the upper surface of the first wavelength-conversion layer 5 can be uniformly radiated outside the apparatus. Accordingly, the light-emitting apparatus can radiate light outside with neither incorrect light distribution shift nor color unevenness.

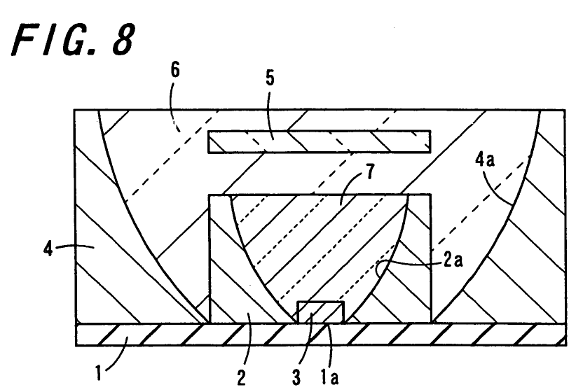

The material of the light transmitting member to be injected inside the first reflecting member may differ from that of the light transmitting member 6 to be injected inside the second reflecting member 4, as a light-emitting apparatus according to an eighth embodiment of the invention shown in FIG. 8. Regarding the light transmitting member 7 injected inside and up to the top end of the first reflecting member 2, and the light transmitting member 6 injected inside the second reflecting member 4, when the refractive index of the light transmitting member 7 is lower than that of the light transmitting member 6, then the light from the light-emitting element 3 or the light reflected on the first inner peripheral surface 2a is propagated into the light transmitting member 6 without undergoing total reflection on the interface between the light transmitting member 7 and the light transmitting member 6, and a part of the phosphor light radiated downward from the first wavelength-conversion layer 5 undergoes total reflection on the interface between the light transmitting member 7 and the light transmitting member 6 and is radiated outside the light-emitting apparatus. In a case where the refractive index of the light transmitting member 7 is higher than that of the light transmitting member 6, then the light from the light-emitting element 3 and the light reflected on the first inner peripheral surface 2a have the advantage of reduced reflection loss while they pass through the interface between the light transmitting member 7 and the light transmitting member 6. The light transmitting member 6 and the light transmitting member 7 may be selected in view of the refractivity difference and the transmittance difference therebetween so that the radiative light intensity of the light-emitting apparatus could be the largest.

Next, a light-emitting apparatus according to a ninth embodiment or the invention is described. The embodiment of the invention is substantially the same as the light-emitting apparatus according to the first embodiment of the invention except that in the former, the placement portion 2b is formed on the first reflecting member 2. The corresponding parts are denoted by the same reference numerals, and a detailed description thereof will be omitted.

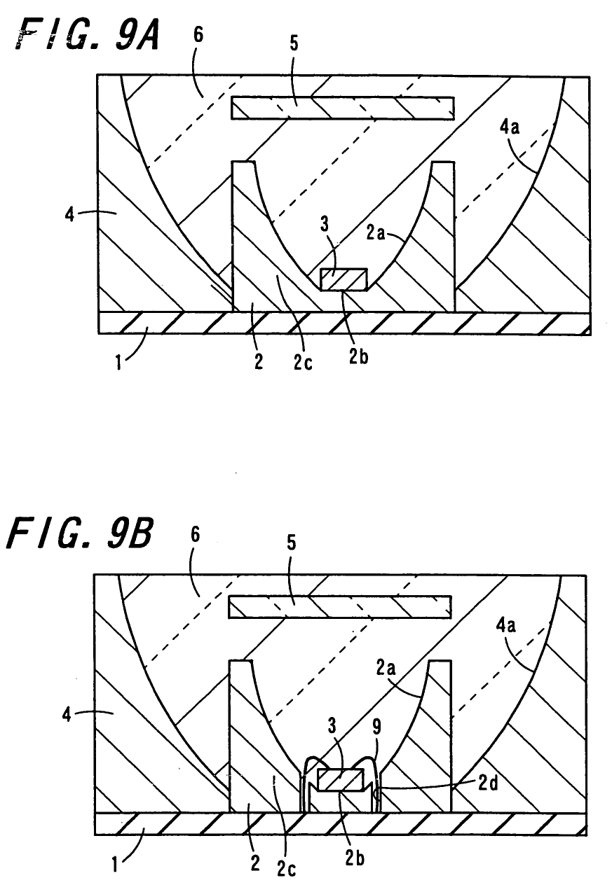

The first reflecting member 2 is so designed that a placement portion 2b for emplacing thereon the light-emitting element 3 is formed on the upper surface thereof, the first reflecting member 2 has a side wall portion 2c which is formed so as to surround the placement portion 2b and includes an inner peripheral surface serving as a light-reflecting surface. The first reflecting member 2 is attached to the center part of the upper principal surface of the base body 1, as shown in FIG. 9A. Outside the first reflecting member 2, disposed is a second reflecting member 4 formed in a frame like shape and having a side wall portion 4c including a second inner peripheral surface 4a serving as a light-reflecting surface, and the second reflecting member 4 is attached to the outer periphery of the upper principal surface of the base body 1. The light transmitting member 6 is injected inside the second reflecting member 4 to cover the light-emitting element 3 and the first reflecting member 2. Above the light-emitting element 3 and inside or on the surface of the light transmitting member G, disposed is a first wavelength-conversion layer 5 for converting the wavelength of the light from the light-emitting element 3, spaced from the first reflecting member 2 and the second reflecting member 4.

According to such a constitution, this makes it possible to undergo wavelength conversion of the light from the light-emitting element 3 by the first wavelength-conversion layer 5, then reflect the converted light radiated downward from the first wavelength-conversion layer 5 upward on the second reflecting member 4 and radiate the reflected light outside the light-emitting apparatus through the gap between the first wavelength-conversion layer 5 and the second reflecting member 4, without being transmitted through the first wavelength-conversion layer 5 again. As a result, the light radiated downward from the first wavelength conversion layer 5 is extremely effectively prevented from being confined within the light-emitting apparatus, and the light emitting apparatus has the advantages of high radiative light intensity, high brightness and high luminous efficiency.

The heat generated by the light-emitting element 3 can be readily conducted to the placement portion 2b and the side wall portion 2c integrated with the placement portion 2b. In particular, when the first reflecting member 2 is formed of a metals the heat can be rapidly conducted to the side wall portion and is well radiated through the outer surface of the side wall portion 2c. As a result, it is possible to prevent the temperature increase in the light-emitting element 3 and to prevent generation of crack of a bonding part of the light-emitting element 3 and the first reflecting member 2 owing to the thermal expansion difference therebetween. Further, the heat of the light-emitting element 3 can be favorably moved not only in the direction of the height of the first reflecting member 2 but also in the outer peripheral direction thereof, whereby the efficient thermal conduction to the base body 1 from the entire lower surface of the first reflecting member 2 results in more effective prevention of the temperature increase in the light-emitting element 3 and the first reflecting member 2, and, as a result, the light emitting element 3 can be stably driven and the inner peripheral surface of the first reflecting member 2 can be prevented from being thermally deformed. Accordingly, the light-emitting apparatus can be driven stably for a long period of time and its good light-emitting capability is kept long.

The light-emitting element 3 is electrically connected to the wiring conductor (not shown) formed on the base body 1 via the bonding wire 9 running through the through-hole 2d formed in the inner peripheral surface 2a that surrounds the placement portion 2b, as shown in FIG. 9B, and this is for power supply to the light-emitting element 3.

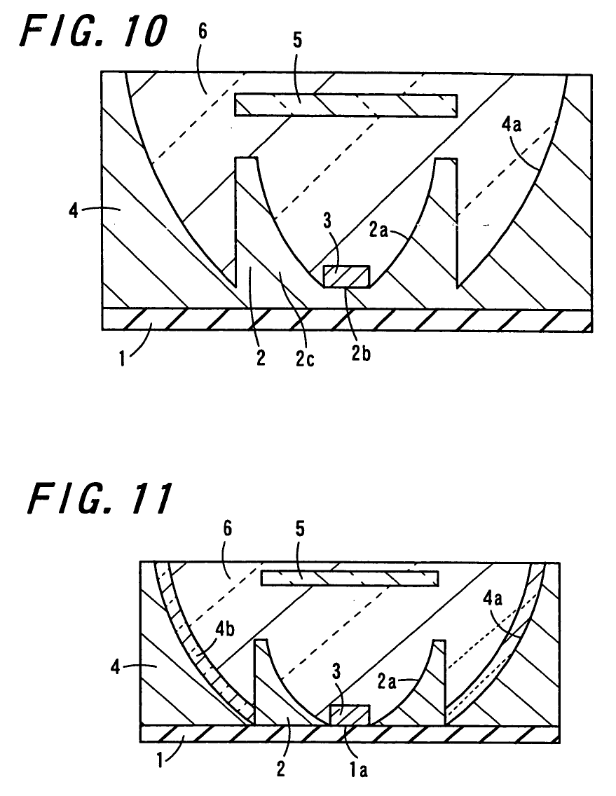

The first reflecting member 2 and the second reflecting member 4 may be integrated by forming them through in-mold molding or cutting, as a light emitting apparatus according to a tenth embodiment of the invention shown in FIG. 10. According to the thus-integrated constitution, the heat of the light-emitting element 3 may be diffused wholly in the light-emitting apparatus via the first reflecting member 2 and the second reflecting member 4 and the heat-radiative area of the light-emitting apparatus increases, and, as a result, the temperature increase in the light-emitting element 3 is prevented.

Furthermore, like in the embodiment of the invention as shown in FIG. 3 or FIG. 4, the placement portion 2b may protrude higher than the lower edge of the side wall portion 2c including the Inner peripheral surface of the first reflecting member 2 therearound. According to such a constitution, the light emitted by the light-emitting element 3 in the oblique downward direction can be reflected upward on the side wall portion 2c and propagated to the first wavelength-conversion layer 5, and as a result, the light from the light-emitting element 3 that can undergo wavelength conversion in the first wavelength-conversion layer 5 increases and the radiative intensity of the light-emitting apparatus therefore increases.

It is possible to apply constitutions described in the embodiments 2 to 8 of the invention to the light-emitting apparatuses according to the ninth and tenth embodiments of the invention.

Preferably, the second reflecting member 4 is so designed that the second inner peripheral surface 4a thereof is coated with a second wavelength-conversion layer 4b serving as a second wavelength-conversion portion for converting the wavelength of the light from the light-emitting element 3, as a light-emitting apparatus according to an eleventh embodiment of the invention shown in FIG. 11. Specifically, the direct light from the light-emitting element 3 and the light that has been reflected on the first inner peripheral surface 2a, then propagated to the first wavelength-conversion layer 5 and further reflected downward without having undergone wavelength conversion by the phosphor material contained in the first wavelength-conversion layer 5 reach the second wavelength-conversion layer 4b formed on the second inner peripheral surface 4a and undergo wavelength conversion therein. The light thus having undergone wavelength conversion is radiated upward from the second wavelength-conversion layer 4b, and is radiated outside the light-emitting apparatus passing through the top surface of the light transmitting member 6 via the gap between the first wavelength-conversion layer 5 and the second reflecting member 4. As a result, in the light-emitting apparatus, even the light from the light-emitting element that is reflected downward and outside, not subjected to wavelength conversion in the first wavelength-conversion layer 5 can undergo wavelength conversion in the second wavelength-conversion layer 4b, and therefore the radiative light intensity and the brightness of the light-emitting apparatus can be increased and the luminous efficiency thereof can be therefore increased.

The light radiated from the second wavelength-conversion layer 4b toward the second inner peripheral surface 4a is reflected on the second inner peripheral surface 4a serving as a light-reflecting surface, and again returns to the second wavelength-conversion layer 4b. Meanwhile, it is possible to apply this constitution to the light-emitting apparatuses according to the ninth and tenth embodiments of the invention shown in FIGS. 9A, 9B, and 10.

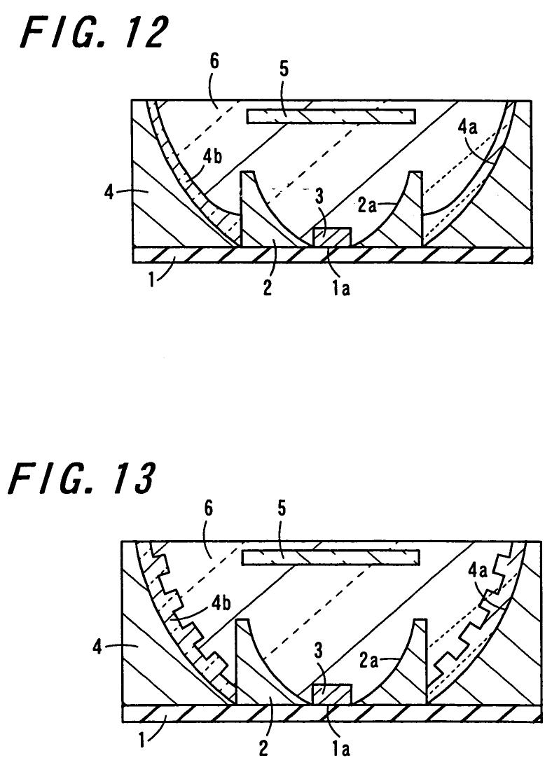

Preferably, the second wavelength-conversion layer 4b is so designed that its thickness gradually increases from the upper end to the lower end thereof, as a light-emitting apparatus according to a twelfth embodiment of the invention shown in FIG. 12. According to such a constitution, at the lower end of the second wavelength-conversion layer 4b at which the distance between the upper surface of the light transmitting member 6 and the second wavelength-conversion layer 4b increases, the thickness of the second wavelength-conversion layer 4b gradually increases and, as a result, the quantity of light from the phosphor material gradually increases at that site. On the other hand, at the upper end of the second wavelength-conversion layer 4b at which the distance between the upper surface of the light transmitting member 6 and the second wavelength-conversion layer 4b decreases, the thickness of the second wavelength-conversion layer 4b gradually decreases and, as a result, the quantity of light from the phosphor material gradually decreases at that site than at the lower end of the layer 4b. Accordingly, the light intensity distribution irradiated upward from the light-emitting apparatus can be uniform in the center part and in the peripheral part and, in addition, the apparatus is free from a problem of color unevenness. Meanwhile, it is possible to apply this constitution to the light-emitting apparatuses according to the ninth and tenth embodiments of the invention shown in FIGS. 9A, 9B, and 10.

Preferably, the second wavelength-conversion layer 4b is so designed that the density of the phosphor material therein gradually increases front the upper end to the lower end thereof. According to such a constitution, at the lower end of the second wavelength-conversion layer 4b at which the distance between the upper, surface of the light transmitting member 6 and the second wavelength-conversion layer 4b increases, the density of the phosphor material in the second wavelength-conversion layer 4b increases and, as a result, the quantity of light from the phosphor material gradually increases at that site. On the other hand, at the upper end of the second wavelength-conversion layer 4b at which the distance between the upper surface of the light transmitting member 6 and the second wavelength-conversion layer 4b decreases, the density of the phosphor material in the second wavelength-conversion layer 4b gradually decreases than at the lower end thereof, and, as a result, the quantity of light from the phosphor material gradually decreases at that site than at the lower end of the layer 4b. Accordingly, the light intensity distribution irradiated upward from the light-emitting apparatus can be uniform in the center part and in the peripheral part and, in addition, color unevenness can be prevent from occurring in the apparatus. Meanwhile, it is possible to apply this constitution to the light-emitting apparatuses according to the ninth and tenth embodiments of the invention shown in FIGS. 9A, 9B, and 10.

Preferably, the second wavelength-conversion layer 4b is so designed that its inner surface has plural recesses or protrusions. Specifically, when the second wavelength-conversion layer 4b is so designed that its inner surface has plural recesses or protrusions as a light-emitting apparatus according to a thirteenth embodiment of the invention shown in FIG. 13, then the surface area of the second wavelength-conversion layer 4b increases. Accordingly, the phosphor material exposed out on the surface of the second wavelength-conversion layer 4b increases, and the phosphor material exposed out on the surface of the second wavelength-conversion layer 4b is irradiated with the light from the light-emitting element 3 that has been transmitted to the first wavelength-conversion layer 5 directly or after reflection on the first inner peripheral surface 2a, and has been reflected downward without having undergone wavelength conversion by the phosphor material contained in the first wavelength-conversion layer 5 to be excited, and the light is readily subjected to wavelength conversion to phosphor light. As a result, the quantity of phosphor light from the phosphor material increases, and phosphor light is efficiently radiated from the second wavelength-conversion layer 4b, and therefore the radiative light intensity, the brightness and the luminous efficiency of the light-emitting apparatus increase.

The light from the light-emitting element 3 that has been transmitted to the first wavelength-conversion layer 5 directly or after reflection on the first inner peripheral surface 2a, and has been reflected downward without having undergone wavelength conversion by the phosphor material contained in the first wavelength-conversion layer 5, and enters the surface of the second wavelength-conversion layer 4a at an obtuse angle near to parallel to the surface thereof shall enter the side surface of the recess and the protrusion at an acute angle near to a right angle, and then the light is propagated into the second wavelength-conversion layer 4b with no reflection thereon. As a result, the incident light entering the second wavelength-conversion layer 4b from the light transmitting member 6 increases. In other words, the transmittance through the interface between the light transmitting member 6 and the second wavelength-conversion layer 4b increases and the light to be subjected to wavelength conversion by the phosphor material in the second wavelength-conversion layer 4b increases. Accordingly, the radiative light intensity, the brightness and the luminous efficiency of the light-emitting apparatus increase. Meanwhile, it is possible to apply this constitution to the light-emitting apparatuses according to the ninth and tenth embodiments of the invention shown in FIGS. 9A, 9B, and 10.

FIG. 14 is a cross-sectional view showing a light-emitting apparatus according to a fourteenth embodiment of the invention. The light-emitting apparatus according to the embodiment has a similar constitution to the light-emitting apparatus according to the first embodiment of the invention. It should be noted that a light reflecting layer 25 is disposed as a replacement of the first wavelength-conversion layer 5, and a wavelength-conversion layer 8 is formed on the inner peripheral surface 4a of the second reflecting member 4. That is, the light-emitting apparatus is essentially comprised of a base body 1; a first reflecting member 2 serving as a first reflecting portion; a light-emitting element 3; a second reflecting member 4 serving as a second reflecting portion; a light transmitting member 6 injected inside the second reflecting member 4; a light-reflecting layer 25 serving as a light-reflecting portion; and a wavelength-conversion layer 8 serving as a wavelength-conversion portion. The light-reflecting layer 25 reflects the light from the light-emitting element 3 and is provided inside or on the surface of the light transmitting member 6 (in FIG. 14, inside the member) disposed above the light-emitting element 3, spaced from the first reflecting member 2 and the second reflecting member 4. The wavelength-conversion layer 8 is attached to the inner peripheral surface 4a of the second reflecting member 4 so as to convert the wavelength of the light from the light-emitting element 3 and to generate phosphor light.

The first reflecting member 2 is bonded to the upper principal surface of the base body 1 so as to surround the placement portion 1a, and the second reflecting member 4 is also attached onto the upper principal surface the base body 1 so as to surround the first reflecting member 2, with a bonding material, for example, a solder material such as soft solder or Ag solder, or a resin adhesive such as epoxy resin. The first reflecting member 2 is bonded with a desired surface accuracy around the light-emitting element 3 (for example, in such a condition that the light-reflecting surface thereof disposed on both sides of the light-emitting element 3 so as to sandwich the light-emitting element 3 therebetween can be symmetric to each other in the vertical cross-section of the light-emitting apparatus) to thereby form the inner peripheral surface (hereinafter referred to as the first inner peripheral surface) 2a; and the second reflecting member 4 is bonded also with a desired surface accuracy around the first reflecting member 2 to thereby form the inner peripheral surface (hereinafter referred to as the second inner peripheral surface) 4a. Accordingly, the light from the light-emitting element 3 is gathered by the first reflecting member 2 to the light-reflecting layer 25 and is reflected thereon, then the reflected light enters the wavelength-conversion layer 8 and undergoes wavelength conversion therein, and the converted light is efficiently radiated outside the light-emitting apparatus by the underlying second reflecting member 4. As a result, the light-emitting apparatus ensures high radiative light intensity, high brightness and improved luminous efficiency.

The light radiated from the second wavelength-conversion layer 8 toward the second inner peripheral surface 4a is reflected on the second inner peripheral surface 4a serving as a light-reflecting surface, and again returns to the wavelength-conversion layer B.

The light from the light-emitting element 3 is gathered by the first reflecting member 2 to the light-reflecting layer 25 in the manner as above, and the light from the light-emitting element 3 therefore enters the light-reflecting layer 25 at various angles. With that, the light having thus entered the layer 25 at various angles runs from the light-reflecting layer 25 toward the second reflecting member 4 also at various angles of reflection, and enters uniformly the second reflecting member 4. After this, the light is uniformly irradiated outside from the light-emitting apparatus, and as a result, the light outputted from the light-emitting apparatus is free from color unevenness.

Preferably, the vertical cross-sectional profile of the wavelength-conversion layer 8 formed on the second reflecting member 4 has a concavely-curved surface. With that, the light radiated downward from the light-reflecting layer 25 is reflected upward by the wavelength-conversion layer B and the second reflecting member 4 with high directional orientation and is radiated outside the light-emitting apparatus. Accordingly, the light-emitting apparatus of the type is most suitable as an illuminating apparatus capable of radiating light efficiently to the irradiated surface.

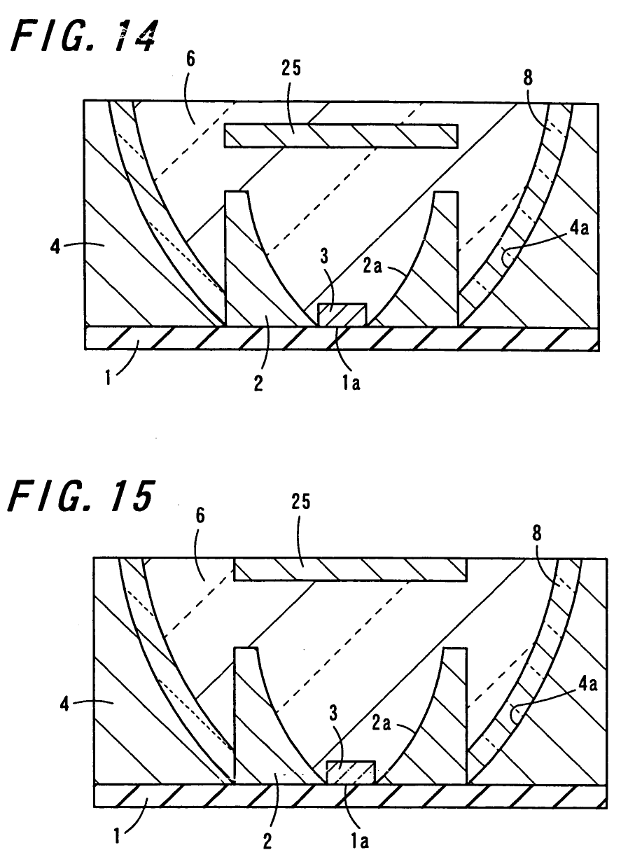

The light-reflecting layer 25 may be disposed above the light-emitting element 3 and inside the light transmitting member 6, spaced from the first reflecting member 2 and the second reflecting member 4, as in FIG. 14. In this case, the light-reflecting layer 25 is effectively prevented from being peeled away from the light transmitting member 6. The light-reflecting layer 25 may be disposed above the light-emitting element 3 and in the surface of the light transmitting member 6, spaced from the first reflecting member 2 and the second reflecting member 4, as a light-emitting apparatus according to a fifteenth embodiment of the invention shown in FIG. 15. In this case, since the gap between the first reflecting member 2 and the light-reflecting layer 25 may be broader, a major part of the light reflected on the light-reflecting layer 25 is more readily led into the wavelength-conversion layer 8 through the broad gap, and, as a result, the luminous efficiency of the light-emitting apparatus can be increased and the radiative light intensity and the brightness thereof can be also increased.

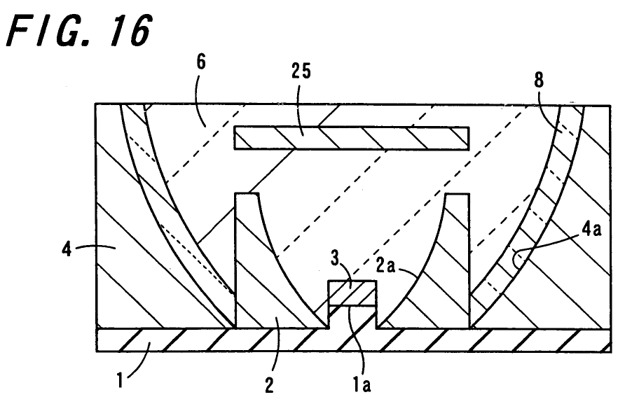

Like in the embodiment of the invention shown in FIG. 3, the height of the placement portion 1a preferably protrudes higher than the lower edge of the inner peripheral surface 2a of the first reflecting member 2, as a light-emitting apparatus according to a sixteen embodiment of the invention shown in FIG. 16. With that, the light emitted in the oblique downward direction by the light-emitting element 3 can be efficiently gathered by the first reflecting member 2 in the upward direction and is reflected on the light-reflecting layer 25 in the downward direction, and, as a result, the quantity of light from the light-emitting element 3 that undergoes wavelength conversion in the wavelength-conversion layer 8 increases and the intensity of light radiation from the light-emitting apparatus increases.

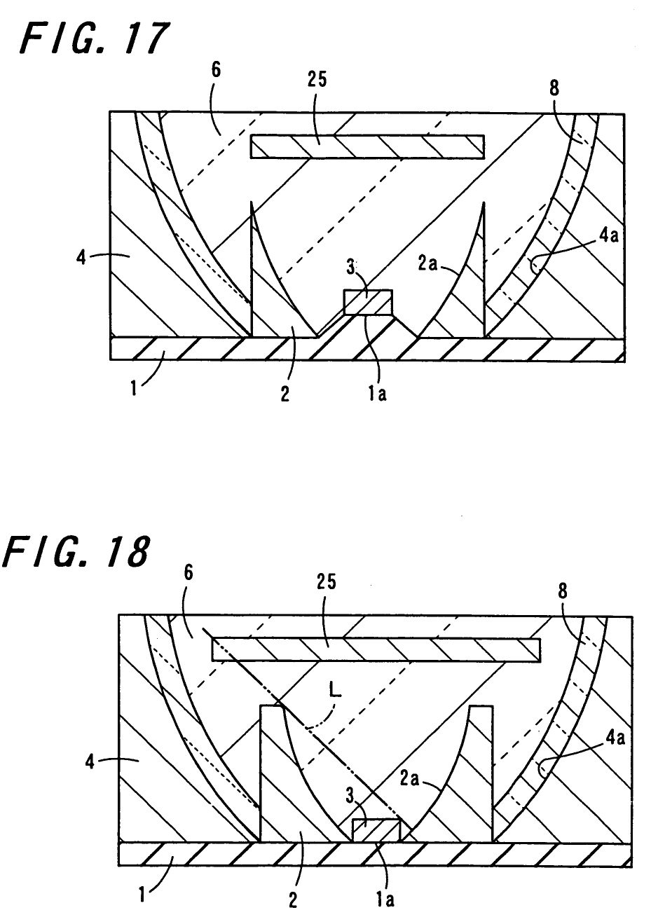

Like in the embodiment of the invention shown in FIG. 4, the placement portion 1a is preferably so designed that its side surface is inclined to expand outward toward the lower side thereof, as in FIG. 17.

Preferably, the arithmetic mean roughness Ra of the first inner peripheral surface 2a and the second inner peripheral surface 4a is from 0.004 to 4 μm. With that, the light from the light-emitting element 3 and the light reflected on the light-reflecting layer 25 can be favorably reflected on the surfaces. In a case where Ra is larger than 4 μm, then the light from the light-emitting element 3 and the light-reflecting layer 25 could not be uniformly reflected on the surfaces and irregular reflection inside the light-emitting apparatus may occur to increase the light loss. On the other hand, in a case where Ra is smaller than 0.004 μm, then the surfaces of the type will be difficult to be stably and efficiently formed.

Furthermore, the first reflecting member 2 may be so modified with no problem that the vertical cross-sectional profile of the outer peripheral surface thereof is curved or plural reflecting members are provided between the first reflecting member 2 and the second reflecting member 4.

Preferably, an outer peripheral surface of the first reflecting member 2 serves as a light-reflecting surface. According to such a constitution, even though part of the light reflected on the second reflecting member 4 does not run upward but runs toward the outer peripheral surface of the first reflecting member 2 inside the light-emitting apparatus, such light may reflect on the light-reflecting layer of the outer peripheral surface of the first reflecting member 2 and may therefore run upward.

Preferably, the distance between the upper edge of the first reflecting member 2 and the lower surface of the light-reflecting layer 25 is from 0.5 to 3 mm. In a case where the distance is smaller than 0.5 mm, then the light reflected downward on the light-reflecting layer 25 will be difficult to be reflected on the second reflecting member 4 disposed outside the first reflecting member 2, and the light radiation efficiency of the apparatus will be difficult to increase. In a case where the distance is larger than 3 mm, then the light from the light-emitting element 3 will be readily radiated outside the apparatus directly through the gap between the light-reflecting layer 25 and the first reflecting member 2 without passing through the wavelength-conversion layer 8, and, as a result, the radiated light will have a trouble of color unevenness and intensity unevenness.

The light transmitting member 6 is formed of a light transmitting resin material such as epoxy resin or silicone resin or formed of light transmitting glass. The light transmitting member 6 covers the light-emitting element 3 and optionally the light-reflecting layer 25, and is injected inside the first reflecting member 2 and the second reflecting member 4. According to such a constitution, the refractivity difference between the inside and the outside of the light-emitting element 3 and the light-reflecting layer 25 is reduced, and more light can be taken out from the light-emitting element 3 and the light-reflecting layer 25. In addition, when the light transmitting member 6 is formed of the same material as the light transmitting material to form the wavelength-conversion layer 8, then the light emission intensity from the light-emitting apparatus is increased and the radiative light intensity and the brightness of the apparatus can be remarkably increased.

The wavelength-conversion layer 8 is formed of a light transmitting material such as epoxy resin, silicone resin or glass that contains therein a phosphor material or a pigment capable of converting the wavelength of the light from the light-emitting element 3. For example, the wavelength-conversion layer 8 is formed by applying a phosphor material-containing silicone resin onto the inner peripheral surface of the reflecting member 4 by the use of a spray or any other tool for spraying the resin mist, followed by heating the sprayed resin so as to cure the silicone resin.

The light-reflecting layer 25 is disposed above the light-emitting element 3, and thereby the light directly from the light-emitting element 3 or the light reflected on the first reflecting member 2 is reflected downward by the light-reflecting layer 25, and then the thus-reflected light passes through the wavelength-conversion layer 8. Accordingly, the wavelength of the light is converted by the phosphor material, and the intended light having a desired wavelength spectrum can be taken out of the apparatus.

The material of the light-reflecting layer 25 is a metal, resin or ceramic having a high reflectivity in the region of from near UV rays to visible rays. The metal includes aluminium; the resin includes polyester, polyolefin and Spectralon (diffusive reflecting member material by Labsphere); and the ceramic includes alumina ceramic. If desired, the surface of a base body of metal, resin or ceramic may be coated with Ag or Au according to a well-known thin-film formation method of plating or vapor deposition to form the light-reflecting layer 25.

For example, in a case where the light-reflecting layer 25 is formed of an aluminium plate, the method of forming the light-reflecting layer 25 includes forming an aluminium disc through die cutting or cutting, and applying a resin mist that contains a light-scattering material such as barium sulfate or titanium oxide onto the surface of the aluminium disc. Thereby, it is possible to form the light-reflecting layer 25 having a high-reflectivity light-scattering surface. For example, a method of fixing the light-reflecting layer 25 inside the light-emitting apparatus includes injecting a material for the light transmitting member 6 into the area nearly up to the top edge of the second reflecting member 4, then thermally curing the injected material, disposing the light-reflecting layer 25 thereon, further injecting an uncured material for the light transmitting member 6 and thermally curing the injected material. Thereby, it is possible to fix the light-reflecting layer 25 inside the light-emitting apparatus.

Preferably, the light-reflecting layer 25 is so positioned that its outer periphery is on the side of the second reflecting member 4 with respect to the line that runs from the edge of the light-emitting element 3 to the upper edge of the inner peripheral surface 2a of the first reflecting member 2 opposite to the edge of the light-emitting element 3, as a light-emitting apparatus according to an eighteenth embodiment of the invention shown in FIG. 18. According to such a constitution, the light from the light-emitting element 3 can be prevented from being directly radiated outside the light-emitting apparatus. As a result, the light-emitting apparatus can radiate light with neither color unevenness nor light distribution unevenness.

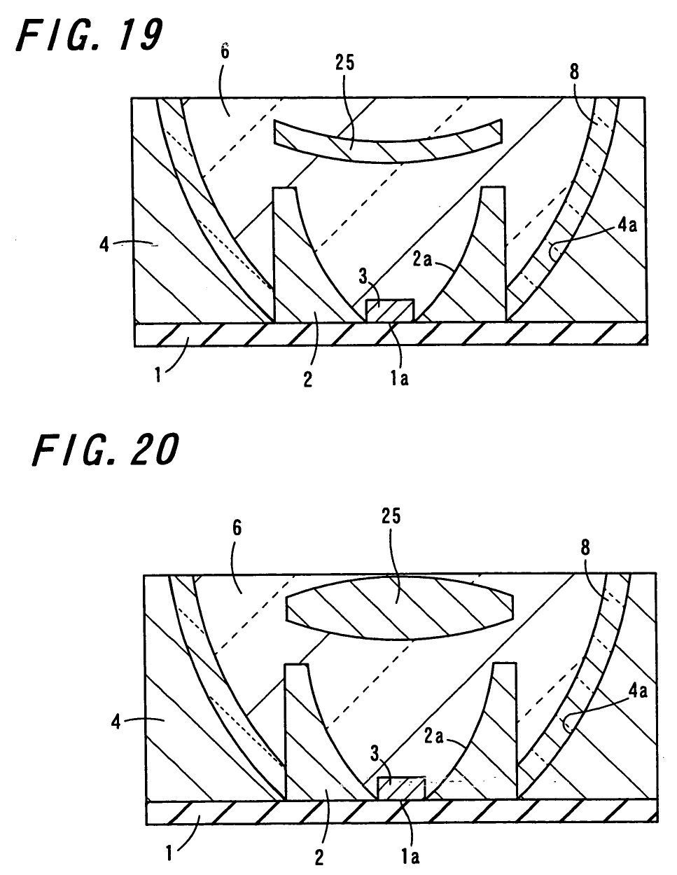

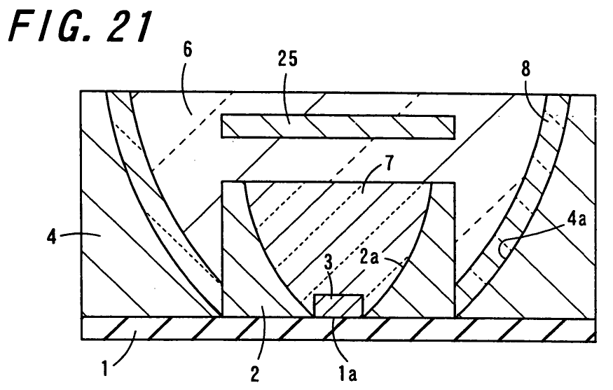

Also preferably, the light-reflecting layer 25 is so designed that its vertical cross section has a surface curved convexly toward the light-emitting element 3, as light-emitting apparatuses according to nineteenth and twentieth embodiments of the invention in FIG. 19 and FIG. 20. According to such a constitution, the light reflected on the lower surface of the light-reflecting layer 25 is led uniformly to the wavelength-conversion layer 8 formed on the second reflecting member 4, and the phosphor color from the wavelength-conversion layer 8 may be prevented from being uneven. Accordingly, the optical properties of the light-emitting apparatus can be thereby improved.

The material of the light transmitting member to be injected inside the first reflecting member 2 may differ from that of the light transmitting member 6 to be injected in the outside of the first reflecting member 2, as a light-emitting apparatus according to a twenty-first embodiment of the invention shown in FIG. 21. For example, the inside and the outside of the first reflecting member 2 may be filled with the light transmitting member 6 having different refractive indexes, and it is desirable that the materials for the light transmitting member 6 are so selected that the light from the light-emitting element 3 can pass through the light transmitting member having a gradually decreasing refractive index toward the outside of the light-emitting apparatus. Concretely, it is desirable that the light transmitting member 7 injected inside the first reflecting member 2 and up to the top edge thereof and the light transmitting member 6 injected inside the second reflecting member 4 are so selected that the refractive index of the light-emitting element 3, the light transmitting member 7, the light transmitting member 6 and the air layer decreases in that order. This is because, regarding the light transmitting member 7, the refractive index of the light-emitting element 3 is extremely high, and therefore it is desirable that the light-emitting element 3 is covered with the light transmitting member 7 having a high refractive index nearer to the refractive index of the light-emitting element 3 in order to take out the light from the light-emitting element 3 as much as possible. In order to prevent total reflection of the light (phosphor light) radiated in all directions from the wavelength-conversion layer 8 formed on the second reflecting member 4, the refractivity difference between an air layer and the light transmitting member 6must be reduced. Accordingly when the refractive index of the light-emitting element 3, [symbol] e light transmitting member 7, the light transmitting member 6 and the air layer is made to decrease in that oro [symbol] then the light loss in the respective interfaces may be reta [symbol] i, and therefore it is desirable that the materials for these components are so selected that the respective components may have the refractive index as in the order as above.

The light transmitting member 6 and the light transmitting member 7 may be selected in consideration of the refractive index difference therebetween and the transmittance thereof so as to maximize the radiative light intensity of the light-emitting apparatus.

A light-emitting apparatus according to a twenty-second embodiment of the invention is described. The embodiment of the invention is substantially the same as the light-emitting apparatus according to the fourteenth embodiment except that in the former, the placement portion 2b is formed on the first reflecting member 2. Accordingly, the corresponding parts are denoted by the same reference numerals, and detailed description thereof will be omitted.

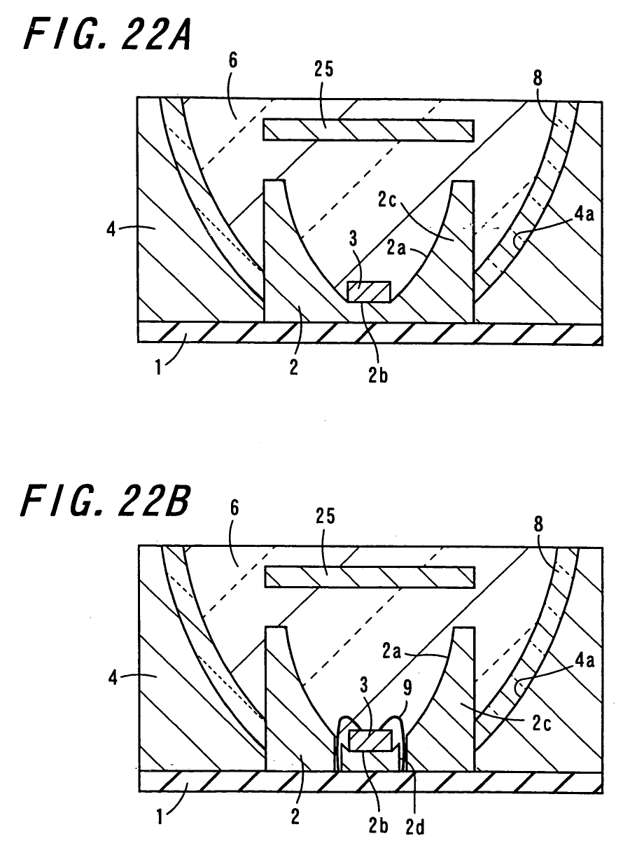

The first reflecting member 2 is so designed that a placement portion 2b for emplacing thereon the light-emitting element 3 is formed on the upper surface thereof, the first reflecting member 2 has a side wall portion 2c which is formed so as to surround the placement portion 2b and includes an inner peripheral surface serving as a light-reflecting surface. The first reflecting member 2 is attached to the center part of the upper principal surface of the base body 1, as in FIG. 22A. Outside the first reflecting member 2, disposed is a second reflecting member 4 formed in a frame-like shape and having a wavelength-conversion layer 8 formed on the second inner peripheral surface 4a thereof, and the second reflecting member 4 is attached to the outer periphery of the upper principal surface of the base body 1. The light transmitting member 6 is injected inside the second reflecting member 4, to cover the light-emitting element 3 and the first reflecting member 2. Above the light-emitting element 3 and inside or on the surface of the light transmitting member 6, disposed is a light-reflecting layer 25 for reflecting the light from the light-emitting element 3, spaced from the first reflecting member 2 and the second reflecting member 4.

According to such a constitution, the light from the light-emitting element 3 is reflected downward on the light-reflecting layer 25, and then led through the wavelength-conversion layer 8, and further reflected upward on the second reflecting member 4, whereby the light is led outside the light-emitting apparatus through the gap between the light-reflecting layer 5 and the second reflecting member 4. As a result, light is effectively prevented from being radiated in all directions including downward the wavelength-conversion layer 8 to be confined within the light-emitting apparatus, and the light-emitting apparatus enjoys increased radiative light intensity and brightness and increased luminous efficiency.

The heat generated by the light-emitting element 3 can be readily conducted to the placement portion 2b and the side wall portion 2c integrated with the placement portion 2b. In particular, when the first reflecting member 2 is formed of a metal, the heat may be rapidly conducted to the side wall portion 2c and to the base body 1 through the entire lower surface of the first reflecting member 2, and after all the heat is favorably radiated outside the base body 1 through the outer surface thereof. As a result, it is possible to prevent the temperature increase in the light-emitting element 3 and to prevent generation of crack of a bonding part of the light-emitting element 3 and the first reflecting member 2 from owing to the thermal expansion difference therebetween. Further, the heat from light-emitting element 3 can be favorably moved not only in the direction of the height of the first reflecting member 2 but also in the outer peripheral direction thereof, whereby the efficient thermal conduction to the base body 1 from the entire lower surface of the first reflecting member 2 results in more effective prevention of the temperature increase in the light-emitting element 3 and the first reflecting member 2, and, as a result, the light-emitting element 3 can be stably driven and the inner peripheral surface of the first reflecting member 2 can be prevented from being thermally deformed. Accordingly, the light-emitting apparatus can be driven stably for a long period of time and its good light-emitting capability is kept long.

The light-emitting element 3 is electrically connected to the wiring conductor (not shown) formed on the base body 1 via the bonding wire 9 running through the through-hole 2d formed in the inner peripheral surface 2a that surrounds the placement portion 2b, as in FIG. 22B, and this is for power supply to the light-emitting element 3.

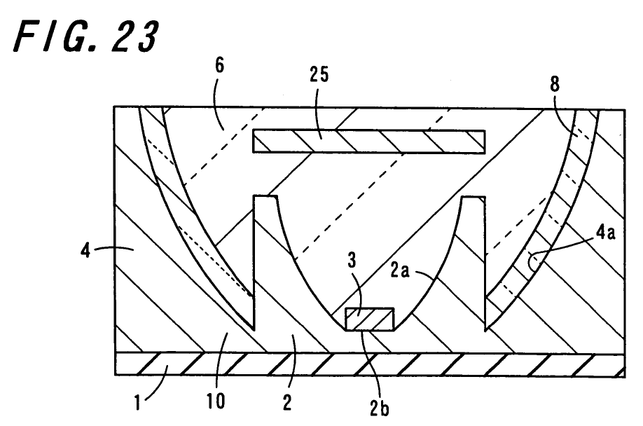

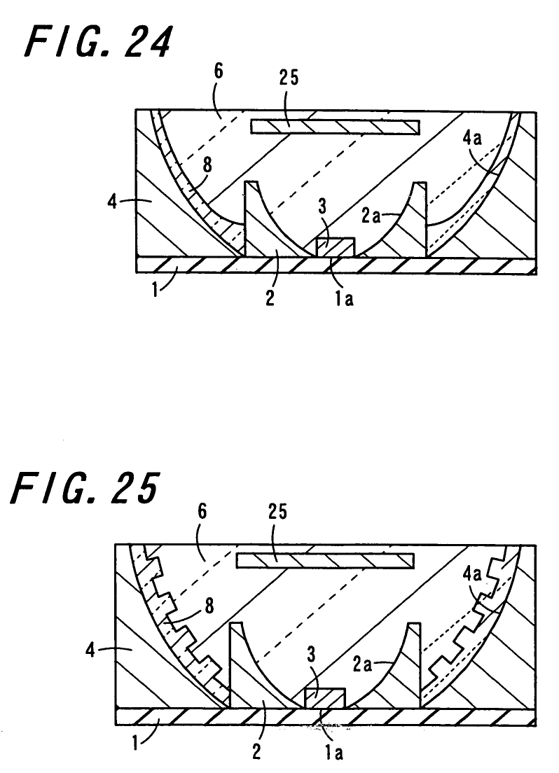

The first reflecting member 2 and the second reflecting member 4 may be integrated into the reflecting member 10 by forming it through in-mold molding or cutting, as a light-emitting apparatus according to a twenty-third embodiment of the invention shown in FIG. 23. According to the thus-integrated constitution, the heat of the light-emitting element 3 may be diffused wholly in the light-emitting apparatus via the first reflecting member 2 and the second reflecting member 4 and the heat-radiative area of the light-emitting apparatus increases, and, as a result, the temperature increase in the light-emitting element 3 is prevented.

Like in the embodiments of the invention as shown in FIG. 16 or 17, the placement portion 2b may protrude higher than the lower edge of the side wall portion 2c including the inner peripheral surface of the first reflecting member 2 therearound. According to such a constitution, the light emitted by the light-emitting element 3 in the oblique downward direction can be reflected upward on the side wall portion 2c and propagated to the light-reflecting layer 25, and as a result, the light from the light-emitting element 3 that is reflected on the light-reflecting layer 25 increases and the radiative intensity of the light-emitting apparatus therefore increases. The constitutions described in the fifteenth to twenty-first embodiments of the invention may be applied to the light-emitting apparatuses according to the twenty-second and twenty-third embodiments of the invention.

Preferably, the wavelength-conversion layer 8 is so designed that its thickness gradually increases from the upper end to the lower end thereof, as a light-emitting apparatus according to twenty-fourth embodiment of the invention shown in FIG. 22. According to such a constitution, at the lower end of the wavelength-conversion layer 8 at which the distance between the upper surface of the light transmitting member 6 and the wavelength-conversion layer 8 increases, the thickness of the wavelength-conversion layer 8 gradually increases and, as a result, the quantity of light from the phosphor material gradually increases at that site. On the other hand, at the upper end of the wavelength-conversion layer 8 at which the distance between the upper surface of the light transmitting member 6 and the wavelength-conversion layer 8 decreases, the thickness of the wavelength-conversion layer 8 gradually decreases and, as a result, the quantity of light from the phosphor material gradually decreases at that site than at the lower end of the layer 8. Accordingly, the light intensity distribution irradiated upward from the light-emitting apparatus can be uniform in the center part and in the peripheral part and, in addition, the apparatus is free from a problem of color unevenness. Mean while, it is possible to apply this constitution to the light-emitting apparatuses according to the twenty-second and twenty-third embodiments of the invention shown in FIGS. 22A, 22B and 23.

Preferably, the wavelength-conversion layer 8 is so designed that the density of the phosphor material therein gradually increases from the upper end to the lower end thereof. According to such a constitution, at the lower end of the wavelength-conversion layer 8 at which the distance between the upper surface of the light transmitting member 6 and the wavelength-conversion layer 8 increases, the density of the phosphor material in the wavelength-conversion layer 8 increases and, as a result, the quantity of light from the phosphor material gradually increases at that site. On the other hand, at the upper end of the wavelength-conversion layer 8 at which the distance between the upper surface of the light transmitting member 6 and the wavelength-conversion layer 8 decreases, the density of the phosphor material in the wavelength-conversion layer 8 gradually decreases than at the lower end thereof, and, as a result, the quantity of light from the phosphor material gradually decreases at that site than at the lower end of the layer 8. Accordingly, the light intensity distribution irradiated upward from the light-emitting apparatus can be uniform in the center part and in the peripheral part and, in addition, color unevenness can be prevented from occurring in the apparatus.

Preferably, the wavelength-conversion layer 8 is so designed that its inner surface has plural recesses or protrusions. Specifically, when the wavelength-conversion layer 8 is so designed that its inner surface has plural recesses or protrusions as a light-emitting apparatus according to a twenty-fifth embodiment of the invention shown in FIG. 25, then the surface area of the wavelength-conversion layer 8 increases. Accordingly, the phosphor material exposed out on the surface of the wavelength-conversion layer 8 increases, and the phosphor material exposed out on the surface of the wavelength-conversion layer 8 is irradiated with the light from the light-emitting element 3 that having been transmitted to the light-reflecting layer 25 directly or after reflection on the first inner peripheral surface 2a, and has been reflected downward and outward on the light-reflecting layer 25 to be excited, and the light is readily subjected to wavelength conversion to phosphor light. As a result, the quantity of phosphor light from the phosphor material increases, and phosphor light is efficiently radiated from the wavelength-conversion layer 8, and therefore the radiative light intensity, the brightness and the luminous efficiency of the light-emitting apparatus increase.

The light from the light-emitting element 3 that has been transmitted to the light-reflecting layer 25 directly or after reflection on the first inner peripheral surface 2a, and has been reflected downward on the light-reflecting layer 25, and enters the surface of the wavelength-conversion layer 8 at an obtuse angle near to parallel to the surface thereof shall enter the side surface of the recess and the protrusion at an acute angle near to a right angle, and then the light is propagated into the wavelength-conversion layer 8 with no reflection thereon. As a result, the incident light entering the second wavelength-conversion layer 8 from the light transmitting member 6 increases. In other words, the transmittance through the interface between the light transmitting member 6 and the wavelength-conversion layer 8 increases and the light to be subjected to wavelength conversion by the phosphor material in the wavelength-conversion layer 8 increases. Accordingly, the radiative light intensity, the brightness and the luminous efficiency of the light-emitting apparatus increase. Meanwhile, it is possible to apply this constitution to the light-emitting apparatuses according to the twenty-second and twenty-third embodiments of the invention shown in FIGS. 22A, 22B and 23.

Next, The light-emitting apparatuses of the invention may be used to constitute an illuminating apparatus. For example, the illuminating apparatus is constructed by setting up a single piece of the light-emitting apparatus in a predetermined arrangement, or by setting up a plurality of the light-emitting apparatuses in a lattice, staggered, or radial arrangement, or by setting up a plurality of concentrically-arranged circular or polygonal light-emitting apparatus units, each of which is composed of a plurality of the light-emitting apparatuses, in a predetermined arrangement. In the illuminating apparatus thus constructed, light emission is effected by exploiting recombination of electrons in the light-emitting element 3 composed of a semiconductor. Thus, the illuminating apparatus has the advantage, in terms of power saving and long lifetime, over a conventional illuminating apparatus for effecting light emission through electrical discharge. The illuminating apparatus can accordingly be designed as a compact, low heat-generation construction. Since the apparatus can be driven efficiently at low power, the quantity of heat from the light-emitting element 3 is small and variation in the center wavelength of the light emitted from the light-emitting element 3 can be suppressed; wherefore the illuminating apparatus is capable of irradiating light with stable radiation light intensity and stable radiation light angle (luminous intensity distribution) for a longer period of time. Moreover, unevenness in color and unbalanced illumination distribution can be prevented from occurring on a to-be-irradiated surface.

Further, by setting up the light-emitting apparatuses of the invention in a predetermined arrangement as light sources, followed by arranging around the light-emitting apparatuses such a component as is optically designed in a given configuration, for example a reflection jig, an optical lens, or a light diffusion plate, it is possible to realize an illuminating apparatus which is capable of emitting light with given luminous intensity distribution.

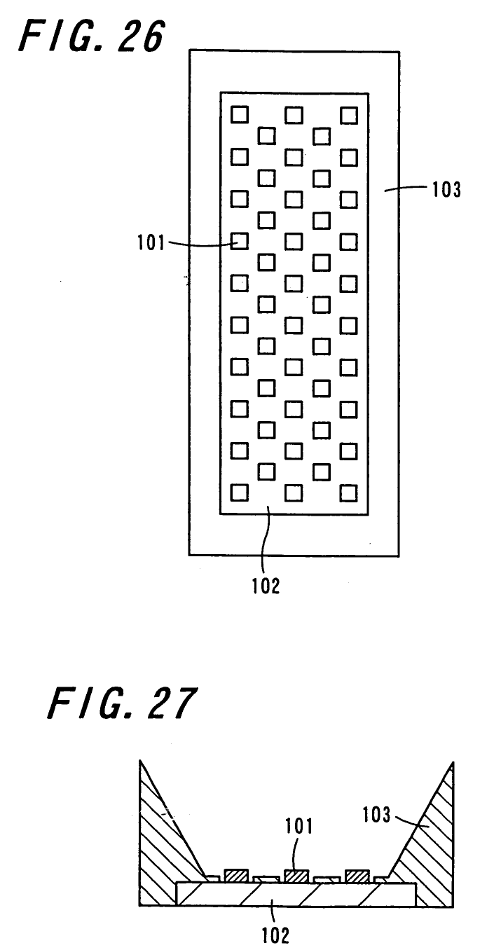

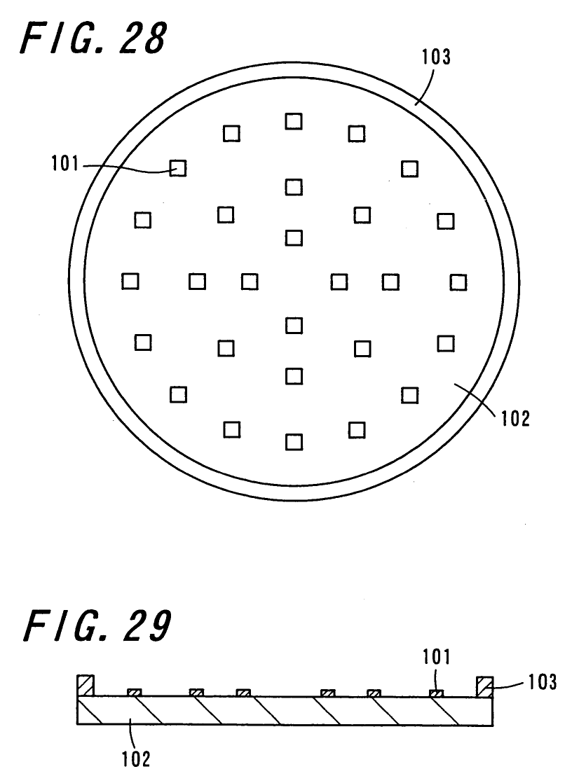

For example, as a plan view shown in FIG. 26 and a cross-sectional view shown in FIG. 27, an illuminating apparatus is composed of a plurality of light-emitting apparatuses 101 arranged in a plurality of rows on a light-emitting apparatus drive circuit board 102; and a reflection jig 103 optically designed in a given configuration, which is disposed around the light-emitting apparatuses 101. In this construction, adjacent arrays of a plurality of the light-emitting apparatuses 101 are preferably so arranged as to secure as sufficient a spacing as possible between the adjacent light-emitting apparatuses 101, that is; the light-emitting apparatuses 101 are preferably staggered. If the light-emitting apparatuses 101 are disposed in a lattice arrangement, that is; the light-emitting apparatuses 101 acting as light sources are arranged rectilinearly, glare will be intensified. An illuminating apparatus having such a lattice arrangement of the light-emitting apparatuses 101 tends to bring discomfort or trouble to human eyes. In view of the foregoing, by disposing the light-emitting apparatuses 101 in the staggered arrangement, it is possible to suppress glare and thereby reduce discomfort or trouble to human eyes. Another advantage is that, since the spacing between the adjacent light-emitting apparatuses 101 can be made as long as possible, it will be possible to effectively suppress thermal interference between the adjacent light-emitting apparatuses 101. Hence, heat confinement within the light-emitting apparatus drive circuit board 102 carrying the light-emitting apparatuses 101 can be avoided; wherefore heat can be dissipated from the light-emitting apparatuses 101 to the outside with high efficiency. As a result, it is possible to provide a long-life illuminating apparatus that has little adverse effect on human eyes and offers stable optical characteristics for a longer period of time. As a plan view shown in FIG. 28 and a cross-sectional view shown in FIG. 29, an illuminating apparatus of another type is constituted by concentrically arranging, on the light-emitting apparatus drive circuit board 102, a plurality of circular or polygonal light-emitting apparatus units, each of which is composed of a plurality of the light-emitting apparatuses 101. In this construction, it is preferable that, in a single circular or polygonal light-emitting apparatus unit, the light-emitting apparatuses 101 are so arranged that the number thereof becomes larger gradually from the center to the outer edge of the illuminating apparatus. This makes it possible to arrange the light-emitting apparatuses 101 as many as possible while securing a sufficient spacing between the adjacent light-emitting apparatuses 101, and thereby enhance the illumination level of the illuminating apparatus. Moreover, by lowering the density of the light-emitting apparatuses 101 in the midportion of the illuminating apparatus, it is possible to avoid heat confinement in the midportion of the light-emitting apparatus drive circuit board 102. Therefore, in the light-emitting apparatus drive circuit board 102, uniform temperature distribution can be observed. Thus, heat can be transmitted to an external electric circuit board or a heat sink with the illuminating apparatus with high efficiency; wherefore temperature rise can be suppressed in the light-emitting apparatuses 101. As a result, it is possible to provide a long-life illuminating apparatus in which the light-emitting apparatuses 101 can be operated with stability for a longer period of time.

The illuminating apparatus such as shown herein will find a wider range of applications including: general-purpose lighting fixtures for indoor or outdoor use: illumination lamps for chandeliers; home-use lighting fixtures; office-use lighting fixtures; store-use lighting fixtures; lighting fixtures for display; street lighting fittings; guidance lights; signal devices; lighting fixtures for stage or studio use; advertisement lights; illumination poles; underwater illumination lights; stroboscopic lights; spotlights; security lighting fixtures embedded in electric poles or the like; lighting fixtures for emergency; electric torches; electric bulletin boards; dimmers; automatic blink switches; backlights for display or other purposes; motion picture devices; ornamental articles; illuminated switches; light sensors; lights for medical use; and vehicle-mounted lights.

The invention is not limited to the embodiments mentioned above, and any modifications and changes may be made therein not overstepping the scope and the sprit of the invention.

For example, for increasing the radiation intensity, plural light-emitting elements 3 may be disposed on the base body 1. The angle of the first inner peripheral surface 2a and that of the second inner peripheral surface 4a, as well as the distance between the upper edge of the second inner peripheral surface 4a and the upper surface of the light transmitting member 6 may be varied in any desired manner to provide a complementary color region, and the light-emitting apparatus may ensure a good color rendering. In addition, the first reflecting member 2 serving as the first reflecting portion and the second reflecting member 4 serving as the second reflecting portion may be integrated with the base body 1. Further, although the wavelength-conversion layers 4b, 5 and 8 are illustrated as an example of the wavelength-conversion portion, various forms may be taken.

Note also that the illuminating apparatus embodying the invention may be constituted by either setting up a plurality of the light-emitting apparatuses 101 in a predetermined arrangement or setting up a single piece of the light-emitting apparatuses 101 in a predetermined arrangement.

### EXAMPLES

### Example 1

Examples of the light-emitting apparatus of the invention are given below. A base body 1 of alumina ceramics was prepared. The base body 1 was integrated with a protruding placement portion 1a, as shown in FIG. 3, and the upper surface of the placement portion 1a was parallel to the upper surface of the base body 1 except the site of the placement portion 1a.

The base body 1 was a rectangular parallelepiped having a size of 17 mm (width)×17 mm (depth)×0.5 mm (thickness), and it had a rectangular parallelepiped placement portion 1a having a size of 0.35 mm (width)×0.35 mm (depth)×0.15 mm (thickness) formed in the center part of the upper surface thereof.

In the site of the placement portion 1a on which a light-emitting element 3 was to be mounted, formed was a wiring conductor which was to electrically connect the light-emitting element 3 to an external electric circuit board via an internal wiring formed inside the base body 1. The wiring conductor was a circular pad having a diameter of 0.1 mm, formed of a metallized layer of Mo—Mn powder, and its surface was coated with an Ni plating layer having a thickness of 3 μm and an Au plating layer having a thickness of 2 μm in that order. The internal wiring inside the base body 1 was formed through a through-hole for electric interconnection. The through-hole was also formed of a metallized conductor of Mo—Mn powder like the wiring conductor.

The first reflecting member 2 was designed in such a manner that the diameter of the uppermost end of the first inner peripheral surface 2a was 2.7 mm, the height was 1.5 mm, and the height of the lower edge of the first inner peripheral surface 2a (the height from the lower surface to be bonded to the upper surface of the base body 1 to the lower side of the inclined surface of the first inner peripheral surface 2a) was 0.1 mm. The profile of the first inner peripheral surface 2a in the cross section perpendicular to the upper principal surface of the base body 1 was a curved surface that satisfied the following formula:
Z₁=(cr₁²)/[1+{1−(1+k)c²r₁²}^{1/2}]
in which Z₁ indicated the height from the lower edge of the first inner peripheral surface 2a, r₁ indicated the radius of the inner dimension, the constant k was −1.053, and the curvature c was 1.818. The arithmetic mean roughness Ra of the first inner peripheral surface 2a was 0.1 μm.

The second reflecting member 4 was designed in such a manner that the diameter of the uppermost end of the second inner peripheral surface 4a was 16.1 mm, the height was 3.5 mm, and the height of the lower edge of the second inner peripheral surface 4a (the height from the lower surface to be bonded to the upper surface of the base body 1 to the lower side of the inclined surface of the second inner peripheral surface 4a) was 0.18 nm. The profile of the second inner peripheral surface 4a in the cross section perpendicular to the upper principal surface of the base body 1 was a curved surface that satisfied the following formula:
Z₂=(cr₂²)/[1+{1−(1+k)c²r₂²}^{1/2}]
in which Z₂ indicated the height from the lower edge of the second inner peripheral surface 4a, r₂ indicated the radius of the inner dimension, the constant k was −2.3, and the curvature c was 0.143. The arithmetic mean roughness Ra of the second inner peripheral surface 4a was 0.1 μm.

An Au—Sn bump was provided on the wiring conductor formed on the upper surface of the base body 1, and the light-emitting element 3 was bonded to the wiring conductor via the Au—Sn bump, and the first reflecting member 2 to surround the placement portion 1a and the second reflecting member 4 to surround the first reflecting member 2 were bonded to the outer periphery of the base body 1 with a resin adhesive.

Using a dispenser, a light transmitting silicone resin for a light transmitting member 6 was injected inside the first reflecting member 2 and inside the second reflecting member 4, and the light transmitting silicone resin was thermally cured in an oven to form a light transmitting member 6.

Further, in the light transmitting member 6, disposed was a tabular first wavelength-conversion layer 5 having a diameter of 5 mm and a thickness of 0.9 mm, which contained three phosphor materials for red emission, green emission and blue emission each of which was excited by the light from the light-emitting element 3, at the height of 2.5 mm from the light-emitting element 3 in such a manner that the layer 5 covered the first reflecting member 2.

Next, a light transmitting member 6 was applied onto the first wavelength-conversion layer 5 with a dispenser, and thermally cured in an oven.

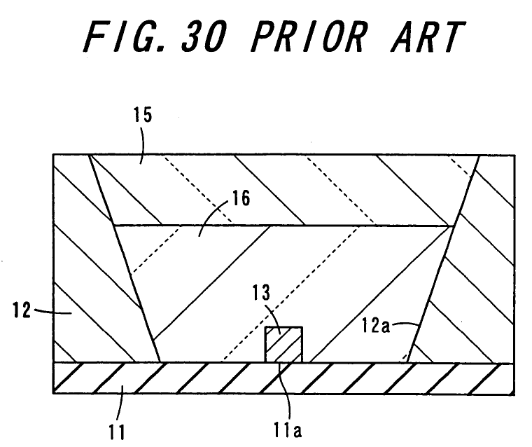

As a comparative light-emitting apparatus, the light-emitting apparatus having the constitution of FIG. 30 was prepared as mentioned above.

In FIG. 30, the light-emitting apparatus was essentially comprised of a light-emitting element 13; a base body 11; a frame reflecting member 12; a wavelength-conversion layer 15; and a light transmitting member 16. The base body 11 was made of an insulating material and had a placement portion 11a for emplacing thereon the light-emitting element 13 which placement portion was disposed in a center part of the upper surface thereof, and wiring conductors (not shown) formed thereon of lead terminals for electrically connecting the inside and the outside of the light-emitting apparatus through the placement portion 11a and a site therearound. The frame reflecting member 12 was bonded and fixed onto the upper surface of the base body 11 in such a manner that its inner peripheral surface 12a was inclined to expand outward toward the upper side of the frame and the inner peripheral surface 12a served as a reflecting surface for reflecting the light from the light-emitting element 13. The wavelength-conversion layer 15 was made of a light transmitting member with a phosphor material (not shown) contained therein for wavelength conversion of the light from the light-emitting element 13. The light transmitting member 16 was injected inside the reflecting member 12 for protecting the light-emitting element 13.

The base body 11 was formed of sintered aluminium oxide (alumina ceramics). A metal paste of W was fired on the upper surface of the base body 11 at a high temperature to form thereon the wiring conductor.

The reflecting member 12 was formed of Al according to a working technique of cutting. The inner peripheral surface 12a of the reflecting member 12 was coated with Al deposited thereon by a vapor deposition. The reflecting member 12 was bonded to the upper surface of the base body 11 with solder in such a manner that its inner peripheral surface 12a surrounded the placement portion 11a.

The light-emitting element 13 was fabricated by forming a light-emitting layer of Ga—Al—N on a sapphire substrate by a liquid-phase growth. The structure of the light-emitting element 13 had an MIS junction (metal insulator semiconductor structure). The light-emitting element 13 was electrically connected to the wiring conductors to the electrode of the light-emitting element 13 disposed on the lower side of the device, via solder bumps, according to the flip chip bonding.

The wavelength-conversion layer 15 was formed by applying a light transmitting material of epoxy resin that contains a phosphor material, onto the upper surface of the light transmitting member 16, followed by thermally curing epoxy resin. The light transmitting member 16 was formed by injecting an epoxy resin inside the reflecting member 12 to cover the light-emitting element 13 followed by thermally curing epoxy resin.

The phosphor material used in the apparatus was a Ce-activated yttrium-aluminium-garnet phosphor.

With a current of 20 mA applied thereto, these light-emitting apparatus were put on and the total luminous flux from them was measured. As a result, the light-emitting apparatus having the constitution of FIG. 30 had a luminous efficiency of 8.5 lm/W, while the light-emitting apparatus having the same outer size dimension but having the constitution of FIG. 3 had a luminous efficiency of 27 lm/W. It is understood that the luminous flux from the light-emitting apparatus of the invention is about 3.2 times that of the conventional apparatus. This confirms the superiority of the light-emitting apparatus of the invention.

### Example 2

Examples of the light-emitting apparatus of the invention are given below. An alumina ceramics base body 1 was prepared. The base body 1 was integrated with a protruding placement portion 1a, as in FIG. 16, and the upper surface of the placement portion 1a was parallel to the upper surface of the base body 1 except the site of the placement portion 1a.

The base body 1 was a rectangular parallelepiped having a size of 17 mm (width)×17 mm (depth)×0.5 mm (thickness), and it had a rectangular parallelepiped placement portion 1a having a size of 0.35 mm (width)×0.35 mm (depth)×0.15 mm (thickness) formed in the center part of the upper surface thereof.

In the site of the placement portion 1a on which a light-emitting element 3 was to be mounted, formed was a wiring conductor which was to electrically connect the light-emitting element 3 to an external electric circuit board via an internal wiring formed inside the base body 1. The wiring conductor was a circular pad having a diameter of 0.1 mm, formed of a metallized layer of Mo—Mn powder, and its surface was coated with an Ni plating layer having a thickness of 3 μm and an Au plating layer having a thickness of 2 μm in that order. The internal wiring inside the base body 1 was formed through a through-hole for electric interconnection. The through-hole was also formed of a metallized conductor of Mo—Mn powder like the wiring conductor.

The first reflecting member 2 was designed in such a manner that the diameter of the uppermost end of the first inner peripheral surface 2a was 2.7 mm, the height was 1.5 mm, and the height of the lower edge of the first inner peripheral surface 2a (the height from the lower surface to be bonded to the upper surface of the base body 1 to the lower side of the inclined surface of the first inner peripheral surface 2a) was 0.1 mm. The profile of the first inner peripheral surface 2a in the cross section perpendicular to the upper principal surface of the base body 1 was a curved surface that satisfied the following formula:
Z₁=(cr₁²)/[1+{1−(1+k)c²r₁²}^{1/2}]
in which Z₁ indicated the height from the lower edge of the first inner peripheral surface 2a, r₁ indicated the radius of the inner dimension, the constant k was −1.053, and the curvature c was 1.818. The arithmetic mean roughness Ra of the first inner peripheral surface 2a was 0.1 μm.

The second reflecting member 4 was designed in such a manner that the diameter of the uppermost end of the second inner peripheral surface 4a was 16.1 mm, the height was 3.5 mm, and the height of the lower edge of the second inner peripheral surface 4a (the height from the lower surface to be bonded to the upper surface of the base body 1 to the lower side of the inclined surface of the second inner peripheral surface 4a) was 0.18 mm. The profile of the second inner peripheral surface 4a in the cross section perpendicular to the upper principal surface of the base body 1 was a curved surface that satisfied the following formula:
Z₂=(cr₂²)/[1+{1−(1+k)c³r₂²}^{1/2}]
in which Z₂ indicated the height from the lower edge of the second inner peripheral surface 4a, r₂ indicated the radius of the inner dimension, the constant k was −2.3, and the curvature c was 0.143. The arithmetic mean roughness Ra of the second inner peripheral surface 4a was 0.1 μm.

Next, a phosphor material-containing silicone resin was sprayed onto the inner peripheral surface 4a of the second reflecting member 4 and cured under heat to form a wavelength-conversion layer 8.

An Au—Sn bump was provided on the wiring conductor formed on the upper surface of the base body 1, and the light-emitting element 3 was bonded to the wiring conductor via the Au—Sn bump, and the first reflecting member 2 to surround the placement portion 1a and the second reflecting member 4 to surround the first reflecting member 2 were bonded to the outer periphery of the base body 1 with a resin adhesive.

Using a dispenser, a light transmitting silicone resin for a light transmitting member 6 was injected into the first reflecting member 2 and the second reflecting member 4 nearly up to the top end of the second reflecting member 4, and the light transmitting silicone resin was thermally cured in an oven to form a light transmitting member 6.

Next, an aluminium disc was formed through die cutting, and its surface was coated with a silicone resin containing barium sulfate as a light-scattering material by spraying the resin thereon to to thereby form a light-reflecting layer 25 having a high-refractivity light-scattering surface. In that manner the light-reflecting layer 25 was disposed on the light transmitting member 6 that had been injected nearly up to the top end of the second reflecting member 4 and thermally cured, and an uncured silicone resin for the light transmitting member 6 was further injected thereover and thermally cured to thereby fix the light-reflecting layer 25 in the member. A light-emitting apparatus was thus constructed.

As a comparative light-emitting apparatus, the light-emitting apparatus having the constitution of FIG. 30 was prepared.

With a current of 20 mA applied thereto, these light-emitting apparatus were put on and the total luminous flux from them was measured. As a result, the light-emitting apparatus having the constitution of FIG. 30 gave 8.5 lm/W, while the light-emitting apparatus having the constitution of FIG. 16 gave 14 lm/W. It is understood that the total luminous flux from the apparatus of the invention is about 1.6 times that of the conventional apparatus. This confirms the superiority of the light-emitting apparatus of the invention.

The invention is not limited to the embodiments and the examples mentioned above, and includes various changes and modifications not overstepping the sprit and the scope of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A light-emitting apparatus comprising:
a light-emitting element;
a base body having, on its upper principal surface, a placement portion for emplacing thereon the light-emitting element;
a first reflecting portion formed in a frame-like shape and on the upper principal surface of the base body so as to surround the placement portion, having an inner peripheral surface serving as a light-reflecting surface;
a second reflecting portion formed in a frame-like shape and on the upper principal surface of the base body so as to surround the first reflecting portion, having an inner peripheral surface serving as a light-reflecting surface;
a light transmitting member provided inside the second reflecting portion so as to cover the light-emitting element and the first reflecting portion; and
a first wavelength-conversion portion for converting a wavelength of light from the light-emitting element, the first wavelength-conversion portion being provided inside or on a surface of the light transmitting member disposed above the light-emitting element, spaced from the first and second reflecting portions.

2. The light-emitting apparatus of claim 1, wherein the second reflecting portions has, on its inner peripheral surface, a second wavelength-conversion portion for converting the wavelength of the light from the light-emitting element.

3. The light-emitting apparatus of claim 1, wherein the first wavelength-conversion portion is so positioned that its outer periphery is on a side of the second reflecting portion with respect to a line that runs from an edge of the light-emitting element to an upper edge of the inner peripheral surface of the first reflecting portion opposite to the edge of the light-emitting element.

4. The light-emitting apparatus of claim 2, wherein the second wavelength-conversion portion is so formed that its thickness gradually increases from its upper end to its lower end.

5. The light emitting apparatus of claim 2, wherein the second wavelength-conversion portion contains a phosphor material for converting the wavelength of the light from the light-emitting element, and is so formed that the density of the phosphor material therein gradually increases from the upper end to the lower end of the second wavelength-conversion portion.

6. The light-emitting apparatus of claim 2, wherein the second wavelength-conversion portion is so formed that its inner surface has plural recesses or protrusions.

7. The light-emitting apparatus of claim 1, wherein a height of the placement portion protrudes higher than a lower edge of the inner peripheral surface of the first reflecting portion.

8. An illuminating apparatus constructed by setting up the light-emitting apparatus of claim 1 in a predetermined arrangement.

9. A light-emitting apparatus comprising:
a light-emitting element;
a tabular base body;
a first reflecting portion formed on an upper principal surface of the base body, having, on its upper surface, a placement portion for emplacing the light-emitting element and a side wall portion including an inner peripheral surface serving as a light-reflecting surface, the side wall portion being formed so as to surround the placement portion;
a second reflecting portion formed in a frame-like shape and on the upper principal surface of the base body so as to surround the first reflecting portion, having an inner peripheral surface serving as a light-reflecting surface;
a light transmitting member provided inside the second reflecting portion so as to cover the light-emitting element and the first reflecting portion; and
a first wavelength-conversion portion for converting a wavelength of light from the light-emitting element, the first wavelength-conversion portion being provided inside or on a surface of the light transmitting member disposed above the light-emitting element, spaced from the first and second reflecting portions.

10. The light-emitting apparatus of claim 9, wherein the second reflecting portions has, on its inner peripheral surface, a second wavelength-conversion portion for converting the wavelength of the light from the light-emitting element.

11. The light-emitting apparatus of claim 9, wherein the first wavelength-conversion portion is so positioned that its outer periphery is on a side of the second reflecting portion with respect to a line that runs from an edge of the light-emitting element to an upper edge of the inner peripheral surface of the first reflecting portion opposite to the edge of the light-emitting element.

12. The light-emitting apparatus of claim 10, wherein the second wavelength-conversion portion is so formed that its thickness gradually increases from its upper end to its lower end.

13. The light emitting apparatus of claim 10, wherein the second wavelength-conversion portion contains a phosphor material for converting the wavelength of the light from the light-emitting element, and is so formed that the density of the phosphor material therein gradually increases from the upper end to the lower end of the second wavelength-conversion portion.

14. The light-emitting apparatus of claim 10, wherein the second wavelength-conversion portion is so formed that its inner surface has plural recesses or protrusions.

15. The light-emitting apparatus of claim 9, wherein a height of the placement portion protrudes higher than a lower edge of the inner peripheral surface of the first reflecting portion.

16. An illuminating apparatus constructed by setting up the light-emitting apparatus of claim 9 in a predetermined arrangement.

17. A light-emitting apparatus comprising:
a light-emitting-element;
a base body having, on its upper principal surface, a placement portion for emplacing thereon the light-emitting element;
a first reflecting portion formed in a frame-like shape and on the upper principal surface of the base body so as to surround the placement portion, having an inner peripheral surface serving as a light-reflecting surface;
a second reflecting portion formed in a frame-like shape and on the upper principal surface of the base body so as to surround the first reflecting portion, having an inner peripheral surface serving as a light-reflecting surface;
a light transmitting member provided inside the second reflecting portion so as to cover the light-emitting element and the first reflecting portion;
a light-reflecting portion for reflecting light from the light-emitting element, the light-reflecting portion being provided inside or on a surface of the light transmitting member disposed above the light-emitting element, spaced from the first and second reflecting portions; and
a wavelength-conversion portion formed on the inner peripheral surface of the second reflecting portion so as to convert the wavelength of the light from the light-emitting element.

18. The light-emitting apparatus of claim 17, wherein the light-reflecting portion is so positioned that its outer periphery is on a side of the second reflecting portion with respect to a line that runs from an edge of the light-emitting element to an upper edge of the inner peripheral surface of the first reflecting portion opposite to the edge of the light-emitting element.

19. The light-emitting apparatus of claim 17, wherein the light-reflecting portion has a light-scattering surface facing the light-emitting element.

20. The light-emitting apparatus of claim 17, wherein the wavelength-conversion portion is so formed that its thickness gradually increases from its upper end to its lower end.

21. The light-emitting apparatus of claim 17, wherein the wavelength-conversion portion contains a phosphor material for converting the wavelength of the light from the light-emitting element, and is so formed that the density of the phosphor material therein gradually increases from the upper end to the lower end of the wavelength-conversion portion.

22. The light-emitting apparatus of claim 17, wherein the wavelength-conversion portion is so formed that its inner surface has plural recesses or protrusions.

23. The light-emitting apparatus of claim 17, wherein a height of the placement portion protrudes higher than a lower edge of the inner peripheral surface of the first reflecting portion.

24. An illuminating apparatus constructed by setting up the light-emitting apparatus of claim 17 in a predetermined arrangement.

25. A light-emitting apparatus comprising:
a light-emitting element;
a tabular base body;
a first reflecting portion formed on an upper principal surface of the base body, having, on its upper surface, a placement portion for emplacing the light-emitting element and a side wall portion including an inner peripheral surface serving as a light-reflecting surface, the side wall portion being formed so as to surround the placement portion;
a second reflecting portion formed in a frame-like shape and on the upper principal surface of the base body so as to surround the first reflecting portion, having an inner peripheral surface serving as a light-reflecting surface;
a light transmitting member provided inside the second reflecting portion so as to cover the light-emitting element and the first reflecting portion;
a light-reflecting portion for reflecting light from the light-emitting element, the light-reflecting portion being provided inside or on a surface of the light transmitting member disposed above the light-emitting element, spaced from the first and second reflecting portions; and
a wavelength-conversion portion formed on the inner peripheral surface of the second reflecting portion so as to convert the wavelength of the light from the light-emitting element.

26. The light-emitting apparatus of claim 25, wherein the light-reflecting portion is so positioned that its outer periphery is on a side of the second reflecting portion with respect to a line that runs from an edge of the light-emitting element to an upper edge of the inner peripheral surface of the first reflecting portion opposite to the edge of the light-emitting element.

27. The light-emitting apparatus of claim 25, wherein the light-reflecting portion has a light-scattering surface facing the light-emitting element.

28. The light-emitting apparatus of claim 25, wherein the wavelength-conversion portion is so formed that its thickness gradually increases from its upper end to its lower end.

29. The light-emitting apparatus of claim 25, wherein the wavelength-conversion portion contains a phosphor material for converting the wavelength of the light from the light-emitting element, and is so formed that the density of the phosphor material therein gradually increases from the upper end to the lower end of the wavelength-conversion portion.

30. The light-emitting apparatus of claim 25, wherein the wavelength-conversion portion is so formed that its inner surface has plural recesses or protrusions.

31. The light-emitting apparatus of claim 25, wherein a height of the placement portion protrudes higher than a lower edge of the inner peripheral surface of the first reflecting portion.

32. An illuminating apparatus constructed by setting up the light-emitting apparatus of claim 25 in a predetermined arrangement.
